(19) United States
(12) Patent Application Publication
(10) Pub. No.: US 2026/0316007 A1
(43) Pub. Date: Oct. 15, 2026

(54) Process for NOx Removal from Fluid Streams

(71) Applicant: Standard H2, Inc., Ravenna, OH (US)

(72) Inventors: Mariavicenta Wasas, Aurora, OH (US); James Wasas, Aurora, OH (US); Terry Mazanec, Aurora, OH (US)

(21) Appl. No.: 19/390,908

(22) Filed: Nov. 17, 2025

Related U.S. Application Data
(63) Continuation-in-part of application No. 19/194,534, filed on Apr. 30, 2025, now abandoned.
(60) Provisional application No. 63/786,015, filed on Apr. 9, 2025.

(51) Int. Cl. B01D 53/94; B01D 53/96; B01J 23/72; B01J 23/94; B01J 37/00; B01J 37/08; B01J 38/02; B01J 38/12

(52) U.S. Cl. CPC B01D 53/9413; B01D 53/96; B01J 23/72; B01J 23/94; B01J 37/0036; B01J 37/088; B01J 38/02; B01J 38/12; B01D 2255/20761; B01D 2255/2092; B01D 2257/404; B01D 2258/012

(57) ABSTRACT

A method, system and apparatus for decreasing the level of NOx emissions in the exhaust from a gasoline or diesel engine, turbine, or other combustion process, comprising a catalytic sorbent, preferably made of a mixed oxide comprising copper oxides for adsorbtion and decomposition of nitrogen oxides, wherein the catalyst sorbent can be recycled or regenerated and reused.

### CROSS REFERENCE TO RELATED APPLICATIONS

This application claims priority to U.S. patent application Ser. No. 19/194,534 filed on Apr. 30, 2025, and thence to U.S. provisional patent applications 63/730,071, filed on Dec. 11, 2024, 63/637,668, filed on Dec. 18, 2024, and 63/786,015, filed on Apr. 9, 2025, each incorporated herein by reference.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a range of processes, devices and compositions for removing nitrogen oxides from fluid streams using a fluid filter.

### Background of the Invention

The health risks of air pollution are of significant concern around the world, and the most concerning are the harmful pollutants emitted from motor vehicles. As a result, over the past four decades, emission standards have become stricter in both developed and developing countries. A variety of different after-treatment systems (ATS) have been successfully developed for the treatment of exhaust gases from vehicles to meet these emission regulations.

Regulations have been developed to minimize the emissions of carbon monoxide (CO), hydrocarbons (HCs), nitrogen oxides (NOx) and particulate matter (PM) from gasoline and diesel vehicles engines. Different after-treatment systems have been developed for the treatment of exhaust gases from gasoline and diesel engines, respectively. The ATS for gasoline engines is based on three-way catalysts (TWCs) that convert CO, NOx, and unburnt hydrocarbons into carbon dioxide (CO2), nitrogen (N2) and water (H2O). Unfortunately, TWC catalytic technology does not work well for the control of NOx emissions produced in diesel engines.

Therefore, selective catalytic reduction (SCR) of NOx into N2 with a reductant such as ammonia or urea has been commercialized for the abatement of NOx from diesel engine vehicles. A complete after treatment system for diesel engines includes catalytic diesel oxidation, particulate filtration, selective catalytic reduction, and ammonia slip catalysis. One problem with the selective catalytic reduction is that, as a practical matter, it is only capable of reducing the NOx to the range of 5 to 9 ppm. Another problem, referred to as slippage, is caused by ammonia passing through the catalyst.

A similar concern arises in the treatment of flue gas from the combustion of hydrocarbons or hydrogen in an engine, boiler, or gas turbine. The US EPA is proposing that combustion controls with the addition of post-combustion SCR is the best system of emission reduction (BSER) for limiting NOX emissions from gas turbines. For large stationary turbines the EPA is proposing an emissions standard of 3 ppm while smaller installations have somewhat higher allowable NOx limits. A further problem of the SCR technology is that the operating conditions required for SCR are only achieved by expensive modifications of the downstream boiler or heat exchanger system, which is a significant issue for turbine installations.

NOx adsorber catalysts, also referred to as lean NOx traps (LNT), have been a commercial NOx reduction technology on light-duty vehicles since around 2000. LNT catalysts are typically composed of at least one precious metal component and one alkali or alkaline-earth component which are supported on a high surface area refractory oxide. These catalysts operate in a cyclic manner, whereby the catalyst stores or “traps” NOx as nitrate species during lean period of operation and the trapped NOx is released and reduced to N2 with a reducing gas during the rich period of operation, thereby regenerating the trapping capacity of the catalyst. An engine operates in a lean condition when there is an excess of air relative to fuel in the combustion chamber while rich operation occurs when there is not enough oxygen for complete combustion of the fuel. Additional reducing gas can also be injected as needed.

The following comprise representative prior art in the field.

Byrne in U.S. Pat. No. 4,961,917 discloses a method of passing ammonia, nitrogen oxides, and oxygen over zeolite-supported iron or copper catalysts to selectively catalyze the reduction of NOx. The fresh copper-promoted catalyst has good activity but deactivates significantly when aged.

Stiles in U.S. Pat. No. 5,362,463 describes a two-step process for removing NOx comprising a first step using a 20-80% b/w manganese oxide sorbent to trap NOx and a second step using a stream of reducing gas such as H2 with a catalyst to reduce NOx to N2. Sorbents that contain other metals and comprise from 5 to 50% b/w alkali metal may be used.

Yamamoto in JP2002248348A discloses a process for removing NOx using a sorbent precursor containing from 1 to 99% b/w trivalent iron and various other metals, that is pretreated or regenerated by reduction with a reducing gas to produce the sorbent containing divalent iron.

Manson, in U.S. Pat. Nos. 6,013,599 and 6,248,689, discloses a diesel exhaust soot oxidation catalyst comprising an acidic iron-containing compound, a copper-containing compound, an acidicvanadium-containing compound solution, and an alkaline earth metal slurry supported on a porous refractory support. NOx removal is not mentioned.

Golden et al, in U.S. Pat. No. 9,700,841, discloses a system comprising two close-coupled catalysts, one of which is a Cu—Mn spinel and the other is a Pt and Rh containing catalyst that can reach a maximum of 99% removal of NO₂ from an exhaust stream. The disclosure is limited to catalysts with a spinel structure.

Golden et al, in U.S. Pat. No. 7,943,097, discloses a selective catalytic reduction reactor system using a catalyst comprising transition metal(s), cerium or a lanthanide, a zeolite, and an oxygen storage material that, with reducing agent NH₃, converts NOx to N₂.

Golden et al, in U.S. Pat. No. 7,767,175, discloses an apparatus for reducing NOx with NH₃ in a gas stream using a catalyst comprising transition metal(s), cerium or a lanthanide, and an acidic material, disposed on a particulate filter.

Yang and Krist, in U.S. Pat. No. 6,033,461, disclose a material composed of 1 to 20% Cu supported on titania and silica for the adsorption and desorption of NO from gas streams. The highest adsorption at elevated temperature was only about 15 mg/g sorbent.

The adsorption of NOx on copper oxides is believed to be a surface reaction such that the capacity of the material is a function of its surface area, i.e. higher surface area materials adsorb more NOx and low surface area materials absorb little or no NOx. The copper oxide with the lowest surface area ever found to measurably adsorb NOx had a surface area of 20.5 m2/g (Sihag et al, “Low ppm NO2 detection through advanced ultrasensitive copper oxide gas sensor,” Discover Nano, 19:107, 2024).

In spite of significant R&D efforts, robust NOx adsorber systems for heavy-duty engines have not been developed. The main challenge has been the NOx adsorber operating temperature window. In Ba-based adsorbers the stored NOx is released at higher temperatures, even at lean conditions, resulting in a loss of NOx conversion. In aged NOx adsorbers, NOx conversion tends to decline rapidly at temperatures above approximately 380° C. Exhaust temperatures above 380° C. are commonly experienced during high load operation of the diesel engine.

A need exists for a robust NOx removal technology that can be applied at higher temperature exhaust conditions and yet be active at low temperatures. The materials, structures, devices, and processes of the present invention provide a technology that satisfies this need.

### BRIEF SUMMARY OF THE INVENTION

In a preferred embodiment, a fluid filter device comprising a housing with adapters at either end to permit the housing to be fitted into a fluid flow system or exhaust system, such housing containing filter media comprising particles and/or one or more porous shaped bodies comprising oxides of copper and one or more oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, or zirconium.

In another preferred embodiment, the fluid filter device as disclosed herein, wherein the housing is cylindrical and contains a replaceable filtering cartridge containing the filter media.

In another preferred embodiment, the fluid filter device as disclosed herein, wherein the particles and/or porous shaped bodies are granular particles ranging in size from about 0.001 mm to about 15 mm, or a porous shaped filter body, or both, such porous shaped filter body or bodies comprising micropores.

In another preferred embodiment, the fluid filter device as disclosed herein, further comprising wherein the filter media comprises catalytically active amounts of one or more of palladium, platinum, gold, and rhodium, wherein the atom ratio of the sum of such elements to that of copper is at least 0.001.

In another preferred embodiment, the fluid filter device as disclosed herein, further comprising wherein the filter media comprises a binder consisting of one of the group of alumina, boehmite, silica, graphite, titania, zirconia, ceria, lanthanum oxides, thoria, aluminosilicates, clays, hydrotalcites, or sols of these, or some combination thereof; such filtering media having a porosity in the range of 0.4 to 0.95 and wherein the particles and/or porous shaped bodies comprise micropores, mesopores, and macropores.

In another preferred embodiment, the fluid filter device as disclosed herein, wherein:
the micropores (less than 2 nm) as a fraction of the total pore volume as measured by mercury porosimetry, is in the range of 0.01 to 0.3;
the mesopores (approximately 2 nm-50 nm) as a fraction of the total pore volume as measured by mercury porosimetry, is in the range of 0.05 to 0.95; and
the macropores (greater than 50 nm) as a fraction of the total pore volume as measured by mercury porosimetry, is in the range of 0.1-0.95.

In another preferred embodiment, the fluid filter device as disclosed herein, wherein the filter media comprises a shaped porous filter block bound together with one or more agglomerating agents and in the shape of a filter cartridge.

In another preferred embodiment, the fluid filter device as disclosed herein, wherein the filter media comprises a honeycomb of one or more of alumina, silica, clay, cordierite (2MgO·2Al₂O₃·5SiO₂), silicon carbide, mullite, zirconia, or ceria, that has been coated with a mixture of oxides of copper and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium.

In an alternate preferred embodiment, a process for removing nitrogen oxides from a fluid stream comprising
placing the fluid filter device as disclosed herein into a fluid stream,
passing the fluid stream through the fluid filter device,
recovering purified fluid as it exits the fluid filter device, and
either processing the recovered fluid further or venting the recovered fluid to the atmosphere.

In another preferred embodiment, the process as disclosed herein, wherein the filter media of the fluid filter device comprises catalytically active amounts of one or more of Pd, Pt, and Rh.

In another preferred embodiment, the process as disclosed herein, wherein the filter media of the fluid filter device comprises from 0.0001 to 0.1% by mass of one or more of Pd, Pt, or Rh.

In another preferred embodiment, the process as disclosed herein, wherein the filter media of the fluid filter device comprises at least 50% by weight oxides of copper.

In another preferred embodiment, the process as disclosed herein, wherein the atom ratio of the sum of magnesium, calcium, strontium, aluminum, silicon, and barium to that of copper is at least equal to 0.02 in the filter media of the filter device.

In another preferred embodiment, the process as disclosed herein, wherein the filter media of the fluid filter device comprises a binder material or materials chosen from among alumina, boehmite, silica, graphite, titania, zirconia, ceria, lanthanum oxides, thoria, aluminosilicates, clays, hydrotalcites, or sols of these, or some combination thereof.

In another preferred embodiment, the process as disclosed herein, wherein the filter media of the fluid filter device is formed into a shaped porous filter block or blocks bound together with one or more agglomerating agents and in the shape of a filter cartridge.

In another preferred embodiment, the process as disclosed herein, comprising the fluid filter device as described herein.

In another preferred embodiment, the process as disclosed herein, wherein the fluid stream containing oxides of nitrogen comprises an exhaust stream from a gasoline or diesel engine, a turbine generator, or a flue gas from a combustion process.

In another preferred embodiment, the process as disclosed herein, wherein the fluid stream is the exhaust stream from a diesel engine.

In another preferred embodiment, the process as disclosed herein, wherein the fluid stream is an exhaust stream that has passed through one or more of particulate filters, hydrocarbon oxidation catalysts, NO oxidation catalysts, selective catalytic reduction catalysts, soot oxidation catalysts, or SOx filters before contacting the fluid filter.

In another preferred embodiment, the process as disclosed herein, wherein the fluid stream is an exhaust stream that has passed through a particle filter before contacting the fluid filter.

In another preferred embodiment, the process as disclosed herein, wherein the fluid stream is an exhaust stream that has passed through a hydrocarbon oxidation catalyst and a particle filter before contacting the fluid filter.

In another preferred embodiment, the process as disclosed herein, wherein the fluid stream is an exhaust stream that has passed through a hydrocarbon oxidation catalyst, a NO oxidation catalyst, and a particle filter before contacting the fluid filter.

In another preferred embodiment, the process as disclosed herein, wherein the fluid stream is an exhaust stream that has passed through a selective oxidation catalyst before contacting the fluid filter.

In another preferred embodiment, the process as disclosed herein, wherein the fluid stream comprises at least 10 ppm NOx by volume.

In another preferred embodiment, the process as disclosed herein, wherein the fluid stream comprises from 1 to 100 ppm NOx by volume.

In another preferred embodiment, the process as disclosed herein, wherein the fluid stream is at a temperature from 20 to 500° C.

In another preferred embodiment, the process as disclosed herein, wherein the fluid stream is at a temperature less than 100° C.

In another preferred embodiment, the process as disclosed herein, wherein the fluid stream is at a temperature greater than 350° C.

In another preferred embodiment, the process as disclosed herein, wherein the fluid filter has been regenerated to restore NOx removal activity.

In another preferred embodiment, the process as disclosed herein, wherein the fluid filter has been regenerated and reactivated to restore NOx removal activity.

In another preferred embodiment, the process as disclosed herein, wherein the fluid filter has been regenerated to restore NOx removal activity by contact with a reducing gas stream followed by reactivation with exposure to an oxygen-containing gas.

In another preferred embodiment, the process as disclosed herein, wherein the regeneration is conducted at a temperature from 80 to 350 C and the reactivation is conducted at a temperature from 100 to 750 C.

In another preferred embodiment, the process as disclosed herein, wherein the regeneration gas comprises a recycled exhaust gas or vapors from a fuel storage tank.

In another preferred embodiment, the process as disclosed herein, wherein the reactivating gas is a recycled exhaust gas or an oxygen-containing stream with less than 15% by volume oxygen.

In another preferred embodiment, the process as disclosed herein, wherein the purified gas stream comprises less than 4 ppb NOx by volume.

In an alternate preferred embodiment, a system for removing NOx from a fluid stream, comprising:
a fluid stream of NOx-containing gas,
the fluid filter device as disclosed herein, and
an exhaust line, a line to a conversion processing facility, or a collection vessel,
   such system comprising the following steps,
placing the fluid filter device in the fluid stream,
passing the fluid stream through the fluid filter device,
recovering purified fluid as it exits the fluid filter device, and,
either processing the recovered fluid further or venting the recovered fluid to the atmosphere.

In another preferred embodiment, the system as disclosed herein, wherein the system further comprises one or more additional filtering or conversion media chosen from among particulate filters, hydrocarbon oxidation catalysts, NO oxidation catalysts, selective catalytic reduction catalysts, soot oxidation catalysts, ammonia slip catalysts, and SOx filter media.

In another preferred embodiment, the system as disclosed herein, wherein the filter media contains granular particles ranging in size from about 0.01 mm to about 15 mm.

In another preferred embodiment, the system as disclosed herein, wherein the fluid filter media comprises a honeycomb of one or more of alumina, silica, clay, cordierite, silicon carbide, mullite, zirconia, or ceria, that has been coated with a mixture of oxides of copper and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium.

In another preferred embodiment, the system as disclosed herein, further comprising two or more fluid filter devices as disclosed herein, wherein the fluid stream runs through the two or more fluid filter devices in succession prior to entering the exhaust line.

In another preferred embodiment, the system as disclosed herein, wherein the filter media are regenerated by treatment with a reducing fluid selected from among H2, C1-C4 hydrocarbons, CO, ammonia, urea, methyl amine, methanol, ethanol, vapors from a diesel fuel storage tank, a recycled purified stream, or some combination of these,

In another preferred embodiment, the system as disclosed herein, wherein the filter media is reactivated by treatment with an oxygen-containing gas.

In another preferred embodiment, the system as disclosed herein, wherein the filter media is regenerated by treatment with a dilute basic water stream of pH from 8 to 11, or a dilute acidic water stream of pH from 2.5 to 5, or both, with either acid or basic treatment first.

In another preferred embodiment, the system as disclosed herein, wherein the system further comprises one or more additional filtering or conversion media chosen from among particulate filters, hydrocarbon oxidation catalysts, NO oxidation catalysts, selective catalytic reduction catalysts, soot oxidation catalysts, ammonia slip catalysts, and SOx filter media.

The invention in any of its aspects may be further characterized by one or any combination of the following features:
providing a fluid filter comprising a filter housing fitted with fluid filter medium or a cartridge composed of fluid filter medium, or both;
wherein the filter medium comprises a composition of granular particles ranging in size from about 0.01 mm to about 15 mm, or a porous shaped body or bodies of filter medium, or both, and the filter medium comprises a mixture of oxides of copper, and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium;
wherein the filter medium comprises at least 25% by weight oxides of copper;
wherein the filter medium comprises at least 50% by weight oxides of copper;
wherein the filter medium comprises at least 80% by weight oxides of copper;
wherein the filter medium comprises from 20 to 95, 25 to 95, 50 to 95, 70 to 95, 80 to 95, or 80 to 99.9% by weight oxides of copper;
wherein the filter medium comprises one or more of the oxides of magnesium, calcium, strontium, aluminum, silicon, and barium;
wherein the atom ratio of the sum of magnesium, calcium, strontium, aluminum, silicon, and barium to that of copper is at least equal to 0.02 in the filter medium composition;
wherein the atom ratio of the sum of magnesium, calcium, strontium, aluminum, silicon, and barium to that of copper is 0.02, 0.05, 0.1, 0.2, 0.25, 0.4, 0.5, or at least equal to 0.05, 0.1, 0.2, or 0.25, or from 0.02 to 0.5, 0.05 to 0.4, or 0.1 to 0.25 in the filter medium;
wherein the filter medium comprises catalytic quantities of rhodium, gold, palladium, or platinum;
wherein the atom ratio of the sum of rhodium, gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05 in the filter medium;
wherein the filter medium comprises a binder;
wherein the binder material or materials are chosen from among alumina, boehmite, silica, graphite, titania, zirconia, ceria, lanthanum oxides, thoria, aluminosilicates, clays, hydrotalcites, or sols of these, or some combination thereof;
wherein the binder is chosen from among alumina, boehmite, silica, or graphite.
wherein the porosity of the filter media in the housing is in the range of 0.4 to 0.95, 0.5 to 0.92, 0.6 to 0.9, or 0.7 to 0.8, or at least 0.4, 0.5, 0.6, 0.7, 0.8, 0.85, 0.90, or 0.95, or no more than 0.95, 0.92, 0.90, 0.85, 0.80, or 0.7;
wherein the fraction of micropores (less than 2 nm) in the filter medium is at least 0.005, 0.01, 0.05, 0.1, 0.2, or from 0.005 to 0.5, 0.01 to 0.3, 0.05 to 0.2, or less than 0.05, 0.1, 0.2, 0.3 or 0.4 of the total pore volume as measured by mercury porosimetry;
wherein the fraction of mesopores (about 2-50 nm) in the filter medium is at least 0.05, 0.1, 0.2, 0.3, 0.4 or 0.5, or from 0.05 to 0.95, 0.1 to 0.95, 0.1 to 0.5, 0.2 to 0.8, 0.3 to 0.7, or 0.4 to 0.6, or less than 0.9, 0.8, 0.7, 0.6, 0.5, or 0.4 of the total pore volume as measured by mercury porosimetry;
wherein the fraction of macropores (greater than 50 nm) in the filter medium is at least 0.1, 0.2, 0.3, 0.4 0.5, 0.6, 0.7, 0.8, 0.9, or 0.95 or from 0.1 to 0.95, 0.1 to 0.9, 0.2 to 0.85, 0.3 to 0.8, or 0.4 to 0.7, or less than 0.95, 0.9, 0.8, 0.7, 0.6, 0.5, or 0.4 of the total pore volume as measured by mercury porosimetry;
wherein the filter medium is prepared from water soluble salts of the component metals by coprecipitation and calcination in air;
wherein a filter medium is prepared by grinding together decomposable salts of the desired elements and pressing these into agglomerates that are then roasted in air to decompose the decomposable portions;
wherein a filter medium is prepared by dissolving decomposable salts into solution and spray dried to form small particles of mixed salts by conventional spray-drying process, and the particles are calcined in air or other gas to decompose the decomposable salts to a mixture of oxides;
wherein oxides or decomposable salts of magnesium, calcium, strontium, or barium are added to pre-existing granular particles ranging in size from about 0.001 mm to about 15 mm and comprising a mixture of the oxides of copper and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium;
wherein the fraction of copper oxides in the pre-existing granular particles is at least 50% by mass, and wherein the atom ratio of the sum of magnesium, calcium, strontium, and barium to that of copper in the filtering medium is at least equal to 0.02;
wherein the atom ratio of the sum of magnesium, calcium, strontium, and barium to that of copper in the granular particles is 0.02, 0.05, 0.1, 0.2, 0.25, 0.4, 0.5, or at least equal to 0.05, 0.1, 0.2, or 0.25, or from 0.02 to 0.5, 0.05 to 0.4, or 0.1 to 0.25;
wherein decomposable ions that can be used in the decomposable salts are chosen from among hydroxides, nitrates, nitrites, carbonates, bicarbonates, hydroxycarbonates, formates, acetates, oxychlorides, oxalates, or the like, or mixtures of these;
wherein a filter body is prepared from a mixture of at least 40, 50, 60, 70, 80, 85, or 90%, or no more than 98, 95, 90, or 80%, or from 40 to 99, 60 to 98, 70 to 95 or 75 to 85% by mass of filter medium, at least 1, 5, 7, 10, 15, 20, or 25%, no more than 5, 7, 10, 15, 20, 25, or 30%, or from 1 to 30, 5 to 25, or 7 to 20% by mass pore former, and at least 0.1, 0.2, 0.5, 1, 2, 3, 4, or 5%, or no more than 15, 10, 7, 5, 3, or 2%, or from 0.1 to 15, 0.2 to 10, or 0.5 to 7% by mass binder, wherein the sum of filter medium, pore former, and binder is no more than 100% by mass;
wherein the pore former is chosen from among wax, starch, graphite, carbon black, saw dust, poppy seeds, cellulose fibers, natural fibers (e.g. jute, hemp, etc.), polymer fibers, and hollow spheres, or some combination thereof.

Wherein the mixture of filter medium, pore former, and binder is shaped into a filter body preform by extrusion, pressing, or additive manufacturing;
wherein the pore formers are removed by solvent extraction, thermal decomposition, or oxidation, or some combination of these, to produce a porous preform;
wherein the preform is calcined in air or other gas to remove remaining pore former and induce particle to particle adhesion to form the porous shaped filter body;
wherein the porous shaped filter body is a spirally wound, honeycomb element, composed of flat and corrugated layers, with a colloidal solution of a ceramic material used as an adhesive to join the sheets together along contiguous areas;
wherein the filter medium is shaped as a honeycomb by extrusion and opposite ends of alternate channels within the honeycomb structure are sealed by a high temperature cement;
wherein the preform is a cylindrical structure;
wherein selected portions of the tubular filter body are sealed with a high temperature cement;
wherein the filter medium is formed into a shaped porous filter block bound together with one or more agglomerating agents and in the shape of a filter cartridge;
wherein a filter block can be formed using agglomerating agent or agents in an amount of about 0.01 to about 25 wt % binder, wherein the weight percent is based on the total weight of the composite filter block;
wherein the filter block has a surface area of at least 1, 2, 5, 10, 25, 50, 75, 100, 200, 300, 400, or 500 m²/g, or from 1 to 10, 2 to 20, 5 to 50, 10 to 1000, 20 to 500, or 50 to 300 m²/g when measured by Brunauer-Emmett-Teller (BET) analysis using N2 adsorption.

A fluid filter device comprising a housing to contain filter medium, particles or porous shaped body or bodies or both of filter medium, and adapters at either end to permit the housing to be fitted into a fluid flow system or exhaust system;
wherein a filter device comprises one or more static mixing devices;
wherein the housing of the filter is cylindrical, rust-resistant, corrosion-resistant, and the filtering medium is contained within the cartridge to prevent migration of the medium past the filter;
wherein the housing comprises stainless steel, corrosion resistant alloys, ceramic compositions, ceramic composites, fiberglass, or some combination of these;
wherein the filter device comprises screens or porous ceramic shaped structures to hold the filter media which may be planar, cylindrical, pleated, or any other configuration which permits the fluid to be purified;
wherein the NOx fluid filter of the present invention replaces one or more items in a conventional fluid purification system;
wherein the filter device is part of a filter system that comprises one or more other filtering or conversion media chosen from among particulate filters, hydrocarbon oxidation catalysts, NO oxidation catalysts, selective catalytic reduction catalysts, soot oxidation catalysts, ammonia slip catalysts, or SOx filter media;
wherein the NOx fluid filter of the present invention is situated after any of: particulate filters, hydrocarbon oxidation catalysts, NO oxidation catalysts, selective catalytic reduction catalysts, soot oxidation catalysts, ammonia slip catalysts, or SOx filter media within the exhaust cleanup system; wherein the NOx fluid filter of the present invention is situated before any of selective catalytic reduction catalysts, soot oxidation catalysts, ammonia slip catalysts, or SOx filter media within the exhaust cleanup system;
wherein the NOx fluid filter replaces the NOx selective catalytic reduction (SCR) catalyst, or ammonia slip catalyst, or both in a conventional fluid purification system;
wherein the NOx fluid filter is placed after the diesel particulate filter (DPF) and before the NH3 injection port in a conventional fluid purification system;
wherein the NOx fluid filter replaces the diesel oxidation catalyst (DOC) or the diesel particulate filter (DPF), or both in a conventional fluid purification system;
wherein the NOx fluid filter is placed after the conventional fluid purification system.

It is intended that each above-listed material, porosity, atom ratio, pore fraction and other value is available for use in combination with each other such value, so long as the two or more are not mutually exclusive. Given the use of combinations of materials and mixtures disclosed and claimed herein, the terms “filter medium” and “filter media” are sometimes used interchangeably herein.

A process for removing NOx from a fluid stream by passing the fluid stream through a NOx removal fluid filter;
wherein a NOx-containing fluid stream is passed through a fluid filter cartridge placed in a fluid filter housing in a fluid line or stream, such fluid filter comprising a cartridge packed with a filter medium composition of granular particles and/or porous, shaped structure or structures and comprising a mixture of oxides of copper and one or more oxides comprising aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, or zirconium;
wherein the filter medium contains catalytically active amounts of one or more of Pd, Pt, and Rh;
wherein the filter medium contains from 0.0001 to 0.1% by mass of one or more of Pd, Pt, or Rh;
wherein the granular particles range in size from about 0.01 mm to about 15 mm;
wherein the fluid filter is at a temperature of at least 20, 30, 50, 80, or 100° C., or no more than 700, 600, 500, 400, or 350° C., or from 20 to 700, 30 to 600, 50 to 550, 80 to 500, 100 to 400, or 150 to 350° C.;
wherein the fluid stream containing oxides of nitrogen comprises an exhaust stream from a gasoline or diesel engine or a turbine generator, or a flue gas from a combustion process;
wherein the fluid stream is an exhaust stream that has passed through one or more of particulate filters, hydrocarbon oxidation catalysts, NO oxidation catalysts, selective catalytic reduction catalysts, soot oxidation catalysts, or SOx filters before contacting the fluid filter;
wherein the fluid stream is an exhaust stream that has passed through a particle filter before contacting the fluid filter;
wherein the filter medium is one of a series of filtering or conversion media used to convert NOx to N2 in the exhaust from a combustion process, wherein the other filtering or conversion media are one or more chosen from among particulate filters, hydrocarbon oxidation catalysts, NO oxidation catalysts, selective catalytic reduction catalysts, soot oxidation catalysts, ammonia slip catalysts, or SOx filter media;
wherein the fluid stream comprises at least 1, 2, 10, 25, 100, 500, 1000, or 2000 ppm NOx by volume, or at least 0.5, 1.0, 3.0, 5.0, or 8.0% by volume NOx, or less than 25, 15, 10, 8, 5, 2, or 1% by volume NOx, or less than 2000, 1000, 500, 100, or 25 ppm NOx by volume, or from 1 to 2000, 1 to 100, 1 to 10, 50 to 1000, or 100 to 1000 ppm NOX by volume, or from 0.2 to 25, 0.5 to 15, or 1.0 to 10% by volume NOx;
wherein the fluid stream is at a temperature of at least 20, 50, 80, 100, 200, 250, 300, 350, or 400° C., or less than 1000, 700, 500, 300, 200, 150, 100, or 85° C., or from 20 to 500, 50 to 200, 50 to 350, 50 to 500, 80 to 100, 80 to 200, 80 to 350, 80 to 500, 80 to 700, or 80 to 1000° C.;
wherein the flow rate of the fluid stream is at least 100, 1,000, 5,000, 20,000, 100,000, 500,000, or 1,000,000 volumes of fluid per volume of adsorbent per hour, or less than 5,000,000, 2,000,000, 1,000,000, 500,000, 150,000, or 100,000 volumes of fluid per volume of adsorbent per hour, or from 100 to 1,000,000, 150,000 to 500,000, 500,000 to 5,000,000, or 1,000,000 to 2,000,000 volumes of fluid per volume of adsorbent per hour, all calculated at standard temperature and pressure;
wherein the fluid filter has been regenerated to restore NOx removal activity;
a process for regenerating NOx fluid filter media that have been used to remove contaminants from gas streams by contact with a reducing gas stream;
wherein the filtering media is regenerated by controlled reaction with a reducing gas stream at a temperature of at least 80, 90, 100, 110, 120, 130, 140, 150, 160, or 170° C., or from 80 to 350, 80 to 250, 100 to 200, 120 to 180, or 130 to 170° C., or no more than 350, 320, 300, 280, 250, or 220° C.; wherein the reducing gas stream comprises NH3, urea, methyl amine, hydrogen, CO, methane, methanol, ethanol, a recycled exhaust gas, vapors from a fuel storage tank, or a mixture of these, to provide a reducing gas stream with less than 15, 10, 7, 5, or 2% by volume reducing gas or from 0.1 to 15, 2 to 10, or 3 to 7% by volume reducing gas;
wherein the temperature during regeneration is controlled by diluting the reducing gas stream with inert gas such as N2, CO2, He, Ne, or a mixture of these, to provide a reducing gas stream with less than 15, 10, 7, 5, or 2% by volume of reducing gas or from 0.1 to 15, 2 to 10, or 3 to 7% by volume of reducing gas;
wherein after regeneration with a reducing gas stream the filtering media are reactivated by exposure to air, dilute air, other oxygen-containing gas, an oxygen-depleted flue gas, or other gas at a temperature of at least 100, 150, 200, 250, 300, 350, 400, 450, 500, 550, 600, or 650° C., or from 100 to 750, 200 to 650, 300 to 600, or 400 to 550° C., or no more than 450, 550, 600, 650, 700, or 750° C.;
wherein the temperature during reactivation is controlled by diluting the oxygen-containing gas stream with inert gas such as N2, CO2, He, or Ne, a recycled exhaust gas, or an oxygen-depleted flue gas, or a mixture of these, to provide an oxygen-containing gas stream with less than 15, 10, 7, 5, or 2% by volume of oxygen or from 0.1 to 15, 2 to 10, or 3 to 7% by volume of oxygen;
wherein the purified gas stream contains less than 100, 50, 10, 4, 1, 0.5, 0.2, 0.1, or 0.05 ppb by volume NOx, or from 0.001 to 50, 0.001 to 10, 0.001 to 4, 0.001 to 0.5, 0.001 to 0.1 ppb by volume NOx;
wherein the purified fluid stream is recovered, processed further, or vented to the atmosphere.

### BRIEF DESCRIPTION OF THE DRAWINGS

FIG. 1 shows a honeycomb filter block with alternate channels plugged to force the gas to pass through the catalytic filter medium.

FIG. 2 shows side view of a cylindrical housing containing a “hollow pineapple” structure.

FIG. 3 shows an end-on view of the structure of FIG. 2.

FIG. 4 shows a fluid stream transversing a static mixing device to remove impurities.

FIG. 5 shows a schematic of a conventional diesel exhaust cleanup system that includes ammonia for selective catalytic reduction of NOx.

FIG. 6 is a schematic of a system for removing NOx from an exhaust fluid wherein the NOx fluid filter (NFF) is placed downstream of the diesel particulate filter (DPF) and a portion of the cleaned exhaust gas is recycled to the process after the DPF.

FIG. 7. is a chart showing flow rate on NO/NOx reduction to N2+O2 with the filter medium of Example 1.

FIG. 8. is a chart showing experimental data for the removal of NO and NO2 from N2 stream containing 1000 ppm NO and 1000 ppm NO2 as a function of temperature using the filter medium of Example 1.

FIG. 9. is a chart showing experimental data for the removal of NO and NO2 from N2 and the temperature as a function of time on stream using the filter medium of Example 1.

FIG. 10. is a chart showing experimental data for the removal of NO and NO2 from N2 as a function of temperature with filter medium of Example 2.

FIG. 11. is a chart showing experimental data for the removal of NO and NO2 from a stream containing O2.

FIG. 12. is a chart showing experimental data for the removal of NO and NO2 from diesel exhaust containing particulates and other impurities.

FIG. 13. is a chart showing experimental data on the regeneration of filter medium that had been used for NOx removal from diesel exhaust from which soot and other impurities had not been removed.

FIG. 14. is a chart showing experimental data for the removal of NO and NO2 from a N2 stream by filter medium that had been regenerated after use for cleanup of diesel exhaust.

FIG. 15 is a chart showing experimental data for the removal of NO and NO2 from a N2 stream by filter medium that had been used for diesel exhaust cleanup and not been regenerated.

FIG. 16 is a chart showing the NOx removal vs time on stream for the combination of a particulate filter and one of the filter media of this invention.

### DETAILED DESCRIPTION OF THE INVENTION

In one embodiment, the invention is a method to purify combustion exhaust gases or other fluids by removing oxides of nitrogen, i.e. NO, NO2, N2O, and/or N2O4, collectively NOx, and other unwanted impurities from fluid streams by passing the fluid through a filter comprising a housing, wherein within such housing is placed a replaceable filtering cartridge containing a filter medium comprising a composition of granular particles ranging in size from about 0.01 mm to about 15 mm, and/or a porous shaped body or bodies, and wherein such composition comprises a mixture of oxides of copper and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium, and the purified exhaust fluid stream is recovered, processed further, or vented to the atmosphere.

For the purposes of this application and the claims contained herein, unless otherwise specified, all listed percentages are determined by total weight of the disclosed components and composition. Copper oxides are the principal components in the compositions of the present invention that are suitable for NOx removal.

Without wishing to be bound by theory, the relevant chemical equations for the reactions of NO2 and NO with copper and copper oxide (CuO) are:

2CuO+2NO2=>2CuNO3 (1)

2CuNO3=>2CuO+N2+2O2 (2)

Net:2NO2=>N2+2O2 (3)

4CuO+2NO=>2Cu(0)+2CuNO3 (4)

2CuNO3=>2CuO+N2+2O2 (5)

2 Cu(0)+O2=>2 CuO (6)

Net:2NO=>N2+O2 (7)

While in Equations (1) through (7) the copper species are represented as discrete compounds, these are merely representations of chemical species on or in the filtering material. Copper oxides are arrays of copper and oxygen atoms or ions that, due to the ability of copper to readily transition between oxidation states of 2+, 1+, and zero (0), are copper oxides of mixed oxidation state. A “copper oxide of mixed oxidation state” refers to a compound containing copper atoms in multiple oxidation states, most commonly a mixture of copper(I) (Cu+) and copper(II) (Cu2+) within the same or similar oxide structure, although neutral copper(0) may be present, often appearing in complex oxide materials where the copper atoms can occupy different crystallographic sites with varying oxygen coordination, leading to a mixed valence state. The term ‘copper oxide’ or ‘copper oxides’ as used herein includes mixtures of oxides of copper such as CuO, Cu2O, and up to 10% by weight metallic copper.

In some embodiments the filtering medium comprises granular particles ranging in size from about 0.001 mm to about 15 mm, or a shaped filter body, or both, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides is at least 50% by mass, and wherein the atom ratio of the sum of magnesium, calcium, strontium, and barium to that of copper is at least equal to 0.02. In some embodiments the atom ratio of the sum of magnesium, calcium, strontium, and barium to that of copper is 0.02, 0.05, 0.1, 0.2, 0.25, 0.4, 0.5, or at least equal to 0.05, 0.1, 0.2, or 0.25, or from 0.02 to 0.5, 0.05 to 0.4, or 0.1 to 0.25.

In some embodiments the filtering medium comprises catalytic quantities of rhodium, gold, palladium, or platinum wherein the atom ratio of the sum of rhodium, gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05.

The filtering medium composition may be prepared as a homogenous mixture with a broad range of grain sizes so that particle sizes can be chosen to minimize fluid bypass during the filtering process regardless of the cross section of the filter. Once the medium is prepared and mixed to ensure uniformity, it is then inserted into the filter cartridge or into such other holder, housing, vessel, mesh bag, or cage through which the contaminant-containing fluid can pass.

Where the filter cartridge or housing is filled with particles of filter mediums, the particle size of the filter medium is not more than 0.2, 0.15, 0.1, 0.075, 0.05, or 0.025 times the diameter of the cartridge or housing diameter, or from 0.001 to 0.35, 0.01 to 0.25, 0.05 to 0.2, or 0.075 to 0.1 times the diameter of the cartridge or housing diameter.

To prepare the inventive granular filtering medium, a solution containing the soluble compounds of copper, optionally soluble salts of magnesium, calcium, strontium, and/or barium, and salts of the other metals is contacted with a solution of sodium, potassium, or ammonium hydroxide, bicarbonate, or carbonate, or a mixture of these, in water to form a homogeneous precipitate of hydroxides, carbonates, bicarbonates, hydroxycarbonates, or some mixture of these, which are collected by filtration, optionally washed with water, dried, and calcined in air to convert the materials to oxides and drive off the unwanted materials. This process produces a mass of homogeneous solid material that is then broken into irregular granules followed by gravimetric sorting of the broken pieces with a rotary screening machine comprising a connected series of rotary sieves arranged as a column or other suitable sizing apparatus. In a preferred embodiment, the column comprises two sieves. The very fine particles that pass through both sieves are used for the very small diameter filters or are agglomerated, the particles that pass through the upper sieve but not through the bottom sieve are used in the medium diameter sized filters, and the largest particles that do not go through the upper sieve are used for large filters or are recycled back for additional size reduction. With this arrangement, a broad but controlled range of particles is available for packing the filter cartridges or for bulk commercial uses. The result is that few of the particles are wasted.

In another embodiment a mixture of oxides of copper and the other metals can be prepared by grinding together decomposable salts of the desired elements and pressing these into agglomerates that are then roasted in air to decompose the decomposable portions to produce the mixed oxide material. In some embodiments the decomposable salts may be dissolved into solution and then spray dried to form small particles of mixed salts by conventional spray-drying process, and the particles calcined in air or other oxidizing gas mixture to decompose the decomposable salts producing particles of mixed oxides. Decomposable ions that can be used in the decomposable salts include hydroxides, nitrates, nitrites, carbonates, bicarbonates, hydroxycarbonates, formates, acetates, oxychlorides, oxalates, or the like, or mixtures of these. The solution or sol of the mixed salts may include various binding agents such as salts of aluminum, silicon, phosphorus, or their complex oxides, hydroxides, nitrates, nitrites, carbonates, bicarbonates, or hydroxycarbonates that contain suspensions of the binding materials. Commercial binding solutions are available.

In some embodiments oxides or decomposable salts of magnesium, calcium, strontium, or barium are added to pre-existing granular particles ranging in size from about 0.001 mm to about 15 mm and comprising a mixture of the oxides of copper and one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides in the pre-existing granular particles is at least 50% by mass, and wherein the atom ratio of the sum of magnesium, calcium, strontium, and barium to that of copper in the filtering medium is at least equal to 0.02. In some embodiments the atom ratio of the sum of magnesium, calcium, strontium, and barium to that of copper is 0.02, 0.05, 0.1, 0.2, 0.25, 0.4, 0.5, or at least equal to 0.05, 0.1, 0.2, or 0.25, or from 0.02 to 0.5, 0.05 to 0.4, or 0.1 to 0.25.

In some embodiments, the average particle size of the filtering medium is from 0.01 mm (0.0004 inch) to 50 mm (2 inch), 0.05 mm (0.002 inch) to 25 mm (1 inch), 0.1 mm (0.004 inch) to 15 mm (0.6 inch), 0.1 mm (0.004 inch) to 5 mm (0.2 inch), 0.5 mm (0.02 inch) to 2.5 mm (0.1 inch), 5 mm (0.2 inch) to 15 mm (0.6 inch), or 10 mm (0.4 inch) to 25 mm (1 inch), where particle size is measured by dynamic image analysis (DIA), static laser light scattering (SLS, also called laser diffraction), dynamic light scattering (DLS) or sieve analysis, or can pass through sieve size 2 inch, 1 inch, 0.5 inch, US ASTM Standard Sieve size 4 (4.75 mm), 10 (2.00 mm), 14 (1.40 mm), 18 (1.00 mm), 35 (0.50 mm), 70 (0.212 mm), 100 (0.127 mm), or US sieve size 140 (0.106 mm), but cannot pass through US ASTM Standard sieve size 400 (0.017 mm), 325 (0.044 mm), 270 (0.053 mm), 140, 70, 35, 18, 14, 10, 4, or 0.5 inch. In some embodiments the surface area of the particles is at least 2, 5, 10, 15, 20, 25, 50, 75, 100, 200, 300, 400, or 500 m2/g, or less than 100, 75, 50, 30, 25, 20, 15, 10, or 5 m2/g, or from 1 to 100, 2 to 75, 4 to 50, 10 to 1000, 20 to 500, or 50 to 300 m2/g when measured by Brunauer-Emmett-Teller (BET) analysis using N2 adsorption.

To prepare the inventive granular filtering medium as random sized roughly spherical grains suitable agglomerating agents (binders) may be used to convert the fine powder into particles of desired size to function as filtering media. This process eliminates the loss of very fine particles that are too small for use in a filter cartridge, and also yields free-flowing media that more easily fills filter cartridges.

The agglomerating agent or agents (binders), provide a means of attachment for the particles of the filter medium. The binder may be any material that will agglomerate the particles and is compatible with the reactant mixture. The binder material is also chosen such that the structural integrity of the composite essentially remains constant under reaction conditions. Binder materials are generally not active as adsorbents, and do not modify the activity or capacity of the adsorbent, but serve to bind particles together and keep individual particles of adsorbent separated from one another. Binder materials are chosen from among alumina, silica, titania, zirconia, ceria, lanthanum oxides, thoria, aluminosilicates, clays, hydrotalcites, or sols of these, or some combination of these. In some embodiments of the invention the binder contains boehmite, silica, or graphite. The binder materials are often introduced as suspensions of precursors of these materials, such as sols, that coalesce and condense to form rigid structures enhancing mechanical and physical properties of the filter medium. A suitable commercial binder is Zircar Ceramics' Alumina Rigidizer/Hardener Type AL-R/H water-based suspension of colloidal alumina hydrate particles.

The filter medium particles are mixed with the binder to form a homogeneous or substantially homogeneous mixture. Alternatively, the filter medium particles, the binder particles, or both, may first be ground into fine particles and then mixed to form a homogeneous or substantially homogeneous mixture. The mixture of the filter medium particles and binder may then be heat and pressure treated, such as with an extruder, compression molder, injection molder, or the like, or a combination comprising at least one of the foregoing, to produce the agglomerate. Depending on the type of binder a lubricant may be used as an additive to facilitate formation of the agglomerate. The lubricant is selected such that filter medium properties are essentially not affected. The formed filter structure may be calcined in air, dilute air, other oxidizing gas, or other gas to form a filter element. The calcination or curing may be conducted at a temperature of at least 300, 400, 500, 600, 650, 700, 750, or 800° C., or no more than 1000, 900, 800, 700, 650, or 600° C., or from 300 to 700, 400 to 1000, 500 to 900, or 600 to 800° C. Optionally, the binder may be at least partially removed from the agglomerated filter medium during the calcination in air or curing at elevated temperature.

A material is “catalytically active” if its presence in or on a composition measurably increases the reaction rate of a reactive species in comparison to a blank reaction or one using that same composition without the added material. A turnover frequency (TOF) can be calculated by dividing the number of substrate molecules converted in a unit of time by the number of atoms of the catalytically active component. TOFs can range from less than one per second to hundreds or even thousands per second.

Platinum group metals Pd, Pt, and Rh are often used in quite small amounts as the catalytically active component in catalyst compositions. Single-atom Pt on Al₂O₃ shows CO-oxidation and selective hydrogenation activity at total Pt loadings as low as 0.02 wt %, with each Pt atom contributing to turnover (Zhang Z., et al. Nature Communications 8, 16100 (2017). “Thermally Stable Single-Atom Pt/m-Al₂O₃ for Selective Catalysis.”; Ding K., et al. Science 350, 189-192 (2015). “Single-Atom Pt Catalysts for CO Oxidation.”). Khivantsev et al. (2020) observed efficient NO+CO reduction over Pd/TiO₂ catalysts containing only 0.005-0.05 wt % Pd (Khivantsev K., et al. ChemRev (2020). “Ultra-Low Amounts of Palladium (0.005-0.05 wt %) Show High Activity for NO Reduction.”). Rhodium has shown (Zhang J., et al. Angew. Chem. Int. Ed. 61, e202114233 (2022). “Rh Single-Atom Catalysts for Hydroformylation on N-Doped Carbon.” Hagemeyer in U.S. Pat. No. 8,927,452 demonstrated the conversion of ethylene to vinyl acetate using catalysts with from 0.05% to 0.8% by mass of Pd or Pt, and the hydrogenation of acetylene containing from 0.01% to 1.0% by mass Pd. In U.S. Pat. No. 11,484,864 Hara disclosed exhaust gas cleanup using oxide supported catalysts wherein the content of the catalytically active material is 0.001% to 30% by mass of a platinum group metal, i.e. Pt, Pd, or Rh.

“Pore volume” refers to the total volume of empty spaces (pores) within a material, while “porosity” is the ratio of that pore volume to the material's total volume, usually expressed as a percentage. Porosity shows what proportion of a material is made up of pores, whereas pore volume shows the total amount of pore space available within the bounds of the material. Porosity is the ratio of the volume of interstices of a material, i.e. empty spaces, to the total volume that it occupies, expressed as a fraction. The pore volume is the total volume of very small openings in adsorbent particles or shaped structure, not including the interstitial spaces, expressed as a volume per mass of material, e.g. cm³/g or m³/kg. Although the units are different, these terms are sometimes used interchangeably.

The porosity of filter media needs to be large enough to allow fluids such as a hot engine exhaust to flow freely into and through the particles or filter block, and yet small enough to provide a robust particle. In some embodiments of the present invention the porosity of filter media as a fraction of the volume of the structure, whether as small particles, large particles, agglomerates, or filter blocks, is in the range of 0.4 to 0.95, 0.5 to 0.92, 0.6 to 0.9, or 0.7 to 0.8, or at least 0.4, 0.5, 0.6, 0.7, 0.8, 0.85, 0.90, or 0.95, or no more than 0.95, 0.92, 0.90, 0.85, 0.80, or 0.7.

Porosity is also influenced by the type of material used, the proportion of pore-forming agent and the sintering temperature. Some methods for porosity analyses are X-ray computed microtomography (MCT), mercury intrusion porosimetry (MIP), geometric calculation, and the Archimedes principle.

Pore sizes and pore size distributions are often critical to adsorption effectiveness; large pores are needed to permit facile flow of fluids and small pores to provide high surface area. The International Union of Pure and Applied Chemistry (IUPAC) classifies pore sizes into three categories: 1) micropores are those with a width of less than 2 nanometers (nm), 2) mesopores are those with a width between 2 nm and 50 nm, and 3) macropores those with a width greater than 50 nm. In some embodiments of the present invention the fraction of micropores (less than 2 nm) is least 0.005, 0.01, 0.05, 0.1, 0.2, or from 0.005 to 0.5, 0.01 to 0.3, 0.05 to 0.2, or less than 0.05, 0.1, 0.2, 0.3 or 0.4 of the total pore volume as measured by mercury porosimetry. In some embodiments of the present invention the fraction of mesopores (about 2-50 nm) is at least 0.05, 0.1, 0.2, 0.3, 0.4 or 0.5, or from 0.05 to 0.95, 0.1 to 0.95, 0.2 to 0.8, 0.3 to 0.7, or 0.4 to 0.6, or less than 0.9, 0.8, 0.7, 0.6, 0.5, or 0.4 of the total pore volume as measured by mercury porosimetry. In some embodiments of the present invention the fraction of macropores (greater than 50 nm) is at least 0.1, 0.2, 0.3, 0.4, 0.5, 0.6, 0.7, 0.8, 0.9, or 0.95 or from 0.1 to 0.95, 0.1 to 0.9, 0.2 to 0.85, 0.3 to 0.8, or 0.4 to 0.7, or less than 0.95, 0.9, 0.8, 0.7, 0.6, 0.5, or 0.4 of the total pore volume as measured by mercury porosimetry.

It has surprisingly been found that materials with modest surface aeas, some as low as 1 or 2 m2/g, are active for the adsorption of NOx from gas streams using materials of the present invention. (see, Sihag et al., paragraph above.) In some embodiments the surface area of the material is at least 1, 2, 5, 10, 25, 50, 75, 100, 200, 300, 400, or 500 m2/g, or less than 100, 75, 50, 30, 25, 20, 15, 10, or 5 m2/g, or from 1 to 10, 2 to 20, 5 to 50, 10 to 100, 20 to 500, or 50 to 300 m2/g when measured by Brunauer-Emmett-Teller (BET) analysis using N2 adsorption.

Porous ceramic materials like catalysts and filter media are produced by a variety of methods, the choice of which is mainly determined by the desired porous structure. Typically, to provide large pores shaped filter bodies are prepared using pore-forming agents mixed with ceramic powders or decomposable powder precursors. These processes enable a very wide range of porosities to be obtained, with controlled pore shape and size distribution.

Pore formers can be used in the preparation of particles or shaped filter bodies to increase access to the internal small pores where adsorption and catalytic reactions take place. Common pore formers include: wax, starch, graphite, carbon black, saw dust, poppy seeds, cellulose fibers, natural fibers (e.g. jute, hemp, etc.), polymer fibers, and hollow spheres, although any material that can be extracted, decomposed, or reacted away to leave behind voids in the final structure is possible. Typically, the pore formers are removed by solvent extraction, thermal decomposition, or oxidation, or some combination of these. Typically pore formers do not modify the reactivity of the adsorbent material.

Porous filter bodies can be prepared from fine particles of the filter medium by forming a shaped object, and permeability can be enhanced by the inclusion of pore formers in the preparation. In some embodiments porous filter bodies are prepared from a mixture of at least 40, 50, 60, 70, 80, 85, or 90%, or no more than 98, 95, 90, or 80%, or from 40 to 99, 60 to 98, 70 to 95 or 75 to 85% by mass of filter medium, at least 1, 5, 7, 10, 15, 20, or 25%, no more than 5, 7, 10, 15, 20, 25, or 30%, or from 1 to 30, 5 to 25, or 7 to 20% by mass pore former, and at least 0.1, 0.2, 0.5, 1, 2, 3, 4, or 5%, or no more than 15, 10, 7, 5, 3, or 2%, or from 0.1 to 15, 0.2 to 10, or 0.5 to 7% by mass binder, with the sum of filter medium, pore former, and binder being no more than 100% by mass. The filter medium, pore former, and binder are optionally combined with a minimal amount of lubricant and shaped by pressure such as extrusion or pressing into the desired shape. The shaped combination of materials is either extracted to remove the pore former, heated to induce the particles to adhere to each other, or some combination thereof to form a preform. The preform is then calcined in air or other oxygen-containing gas to remove remaining pore former and induce particle to particle adhesion to form the shaped filter body.

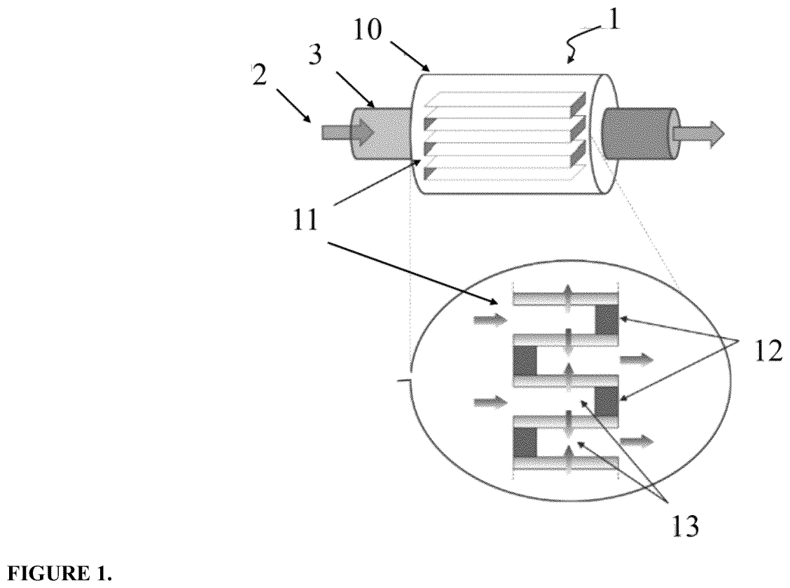

In some embodiments the final shape is that of a spirally wound, honeycomb element, composed of flat and corrugated layers, with a colloidal solution of a ceramic material used as an adhesive to join the sheets together along contiguous areas. In some embodiments the filter medium is shaped as a honeycomb by extrusion. Opposite ends of alternate channels within the honeycomb structure are sealed by a high temperature cement as in FIG. 1.

In some embodiments the fluid filter body comprises a honeycomb of one or more of alumina, silica, clay, cordierite (2MgO·2Al₂O₃·5SiO₂), silicon carbide, mullite, zirconia, or ceria, that has been coated with a mixture of oxides of copper and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium;

In another embodiment, the inventive filtering medium may be formed into a porous block bound together with one or more agglomerating agents and in the shape of a filter cartridge. The filter block may be held together by an agglomerating agent or agents chosen from among silica sols, alumina sols, porous clay, or a combination comprising at least one of these materials. In some embodiments the filter block can be formed using agglomerating agent or agents is in an amount of about 0.01 to about 25 wt % binder, and wherein the weight percent is based on the total weight of the composite filter block. In some embodiments the filter block has a surface area of at least 2, 5, 10, 25, 50, 75, 100, 200, 300, 400, or 500 m2/g, or from 2 to 20, 5 to 50, 10 to 100, 20 to 500, or 50 to 300 m2/g when measured by Brunauer-Emmett-Teller (BET) analysis using N2 adsorption.

In some embodiments the shape of the filter block and the filter cartridge are cylindrical, with the filter block sized to snugly fit within the filter cartridge, and the filter cartridge designed to fit within the housing such that fluid is not permitted to bypass the filter block. In other embodiments, the filter cartridge comprises a filter housing, within which are centered two filter discs, with particulate filtering medium contained between the two filter discs and with a spring or springs between two of the filter discs pushing the media together to prevent media bypass. The filter cartridge is connected to an inlet line on the inlet side of the filter and an outlet located on the opposite end of the filter. In another embodiment the filter cartridge is a hollow cylinder positioned within a housing such that the fluid is forced to pass through the pores of the filter.

### DETAILED DESCRIPTION OF THE FIGURES

FIG. 1 shows an embodiment of the inventive filter 1 that utilizes a honeycomb filter block 11 set within a preferably cylindrical filter housing 10 with alternate channels 13 plugged by plugs 12 on alternate ends. In this way the fluid 2 enters one set of channels that is plugged on the exit end, is forced to pass through a wall of the honeycomb blocks, and is then allowed to exit out of the end of the channels that are open on the exit end and plugged near the entrance. The housing outside the honeycomb filter block prevents the fluid from bypassing the filter block and directs the flow into the channels.

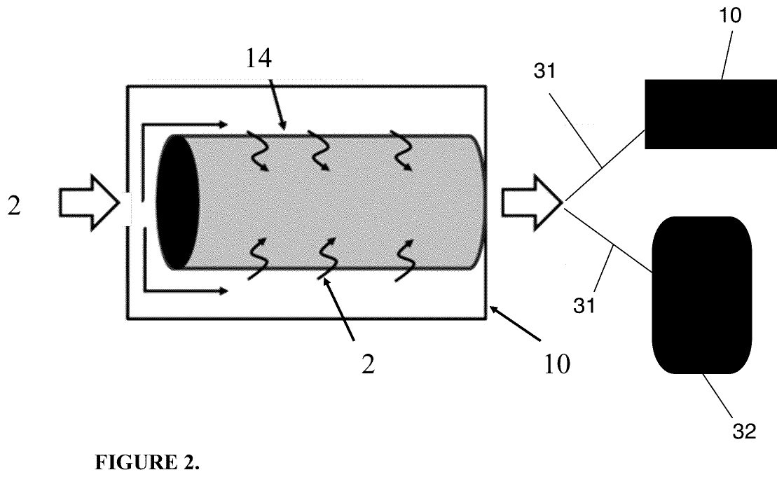

In some embodiments, an internal fixed structure is a so-called ‘hollow pineapple’ that comprises a cylindrical structure of the filter medium or a cylinder coated with the filter medium. The hollow pineapple structure 14 is configured in the filter housing 10 as in FIG. 2 such that inlet fluid 2 passes over the outside of the cylinder and cannot directly pass into the inside of the cylinder, thus forcing the fluid 2 to pass through the walls of the cylinder. The cylinder can be a closed end cylinder as shown in FIG. 2, or it can be configured such that the two end surfaces of the open cylinder are impervious to flow and are attached to the housing to prevent the feed fluid from directly entering the internal channel of the cylinder; i.e. the fluid is forced to pass through the filter medium. The hollow pineapple is a single channel version of the honeycomb filter element described above. The iteration of FIG. 2 also shows exhaust line 31 optionally venting from the first housing to either a second housing 10 containing another filter for further processing or to a collection vessel 32, it being understood that a second or subsequent filtration will again exhaust its contents for further processing or collection.

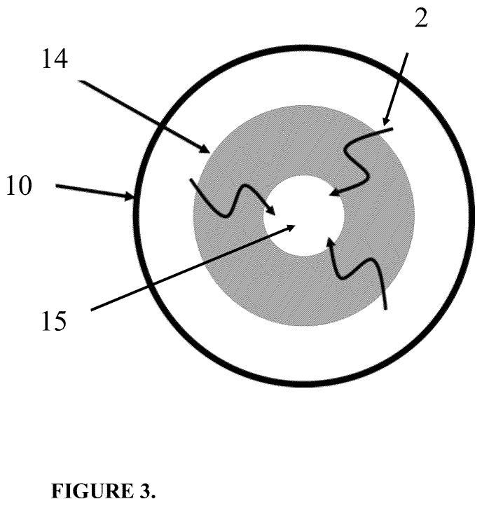

FIG. 3 shows an end view of a cylindrical ‘hollow pineapple’ structure 14 within the filter housing 10, with the fluid 2passing through the hollow pineapple walls and to an interior chamber 15 for eventual outflow.

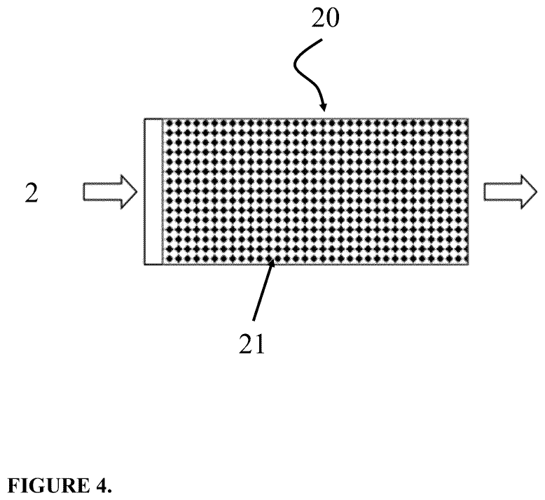

An embodiment of a filter vessel 2 using a static mixing device 20 to remove impurities is shown schematically in FIG. 4. In FIG. 4 the vessel is a cylindrical vessel fitted with internal fixed (non-moving) structures 21 that increase fluid-to-surface contact as the fluid 2 flows through the vessel. The fixed structures can be baffles, or spheres with or without passages within them, or shaped articles like beryl saddles, or packing rings, or Raschig rings, or sponges comprising numerous pores, or screens, or nets, or other shaped structure or some mixture of these structures that enhances contact of the fluids with the packings. Preferably the fixed structures within the vessel are structures that offer minimal pressure drop while still providing good fluid-solid contact such as open nets, screens, or baffles, or the like. The fixed structures can be made of the filter medium or a ceramic or metal support with filter medium coated thereon. A static mixing device as shown in FIG. 4 can be used as the filter element or in tandem with one of the other shaped structures, depending on the role the element is fulfilling in the fluid purification process. Static mixing devices are most useful as trapping components or as catalytic elements in a fluid cleaning process.

Permeability is a parameter used to determine a material's ability to allow fluid to flow through it. Permeability is mainly controlled by pore volume, pore size, surface roughness, particle shape (for packed beds), path length through the material (for sheets or porous cylinders), and interstitial volume (space between particles in a bed of material). However, this parameter is not an intrinsic characteristic of the material, as it also depends on the fluid's viscosity. Gas permeability of sheets such as clothes, nets, paper filters, or porous shaped filter bodies may be determined by measuring the ventilation resistance using a gas permeability measuring device such as a KES-F8-AP1 by Kato Tech of Japan.

Air permeability can also be used to measure how easily fluids can pass through a bed of particles. Air permeability is used to characterize particle size, surface area, and flow properties. The measurement of gas permeability provides an indication that the interstices are interconnected with one another. This method is based on measuring the time required for the passage of a certain volume of air through a layer of the investigated solid material and utilizes a Blaine's air-permeability apparatus or a Blaine meter, as used in industry standard test ASTM C204-18.

In some embodiments a fluid filter device comprises a housing to contain filter medium, particles or porous shaped body or bodies or both of filter medium, and adapters at either end to permit the housing to be fitted into a fluid flow system or exhaust system. In some embodiments the filter device comprises one or more static mixing devices.

In a preferred embodiment, the housing of the filter will be cylindrical, rust-resistant, corrosion-resistant, and the filtering medium will be contained within the cartridge to prevent migration of the medium past the filter.

The filter housing can be composed of any material that will resist the temperature and pressure of the fluid being filtered, such as stainless steel, other known corrosion resistant alloys, ceramic, ceramic composites, or compositions such as fiberglass, etc. Preferably, the filter housing is stainless steel, carbon steel, or a corrosion resistant metal alloy.

Used filter blocks can be recycled or regenerated depending on the use of the filter. The useful lifetime of the filter is dependent upon the concentration of the contaminant in the fluid stream being filtered. Preferably a filter block would be useful for the at least the time between regular maintenance so that it does not require separate attention, more preferably the filter block would be useful for at least a year in service, most preferably the filter block would be useful for the entire life of the vehicle or installation in which it is used.

In some embodiments, the filtering media is held between screens or porous ceramic shaped structures with the fluid stream passing through the media, which screens or structures may be planar, cylindrical, pleated, or any other configuration, which permits the fluid to be purified.

Other embodiments of the disclosed sorption filter and granular media may include combinations with one or more supplemental fluid filtering components, including additional filtering component(s) taken from the group comprising mechanical filters, absorption filters, adsorption filters, sequestration filters, and other commercially known types. In other embodiments, the invention envisions a process wherein the fluid filtering process using the inventive filter media is one of a series of filtering or conversion processes used to remove NOx from a fluid stream, wherein the other process is one or more of diesel oxidation catalysis (DOC), diesel particulate filtration (DPF), selective catalytic reduction (SCR), and ammonia slip catalysis (ASC), or some combination of these. In some embodiments the fluid purification system comprises a SOx filter medium.

In a preferred embodiment, a contaminant-containing stream is passed through a fluid filter cartridge placed in a fluid filter housing in a fluid line, such fluid filter comprising a cartridge packed with a filteri medium composition of granular particles or porous, shaped structure or structures and consisting of a mixture of oxides of copper and one or more oxides comprising aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, or zirconium, and, optionally, catalytically active amounts of one or more of Pd, Pt, and Rh.

In another preferred embodiment, a process is disclosed wherein the filter medium described herein is one of a series of filtering or conversion media used to convert NOx to N₂ in the exhaust from a combustion process, wherein the other filtering or conversion media are one or more chosen from among particulate filters, hydrocarbon oxidation catalysts, NO oxidation catalysts, selective catalytic reduction catalysts, soot oxidation catalysts, ammonia slip catalysts, or SOx filter media.

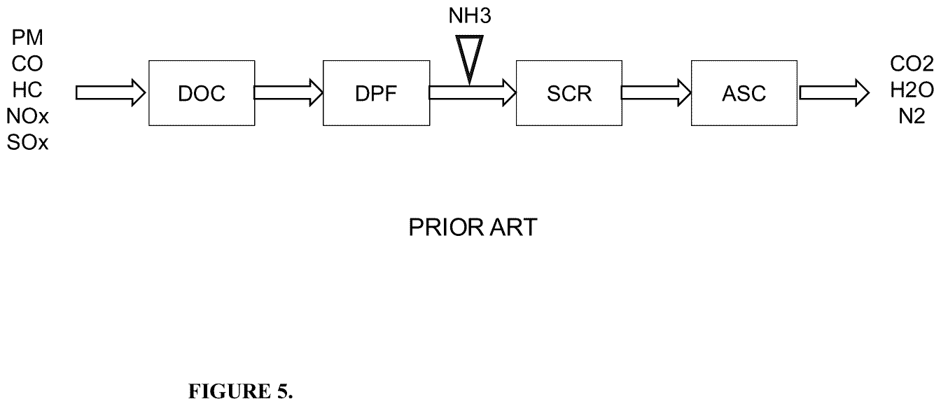

A schematic of a conventional diesel exhaust cleanup system that includes ammonia for selective catalytic reduction of NOx, is presented in FIG. 5.
PM=Particulate Matter
HC=Hydrocarbons
DOC=diesel oxidation catalysis
DPF=diesel particulate filtration
NH3=ammonia injection system
SCR=selective catalytic reduction
ASC=ammonia slip catalysis

Due to its capacity to adsorb NOx and its ability to catalyze several reactions of the components of diesel exhaust, the NOx fluid filter (NFF) of the present invention can be situated in any of several positions within an exhaust cleanup system, or could replace one or more items in a conventional system to greatly improve the efficiency and effectiveness of NOx removal. In some embodiments, the NFF could replace the ASC as it has substantial ammonia conversion activity. In some embodiments, the NFF could replace the SCR, or both the SCR and ASC since it has very substantial activity for NH3 reaction with traces of NOx. In some embodiments, the NFF could be placed after the DPF and before the injection port for the NH3 to trap NOx and extend the life of the NH3 injection system. In some embodiments, the NFF could be placed after the conventional system to trap and remove final traces of NOx or SOx or both that are not removed by the conventional system. In some embodiments, formulations of the NFF that include specific elements could replace the DOC or the DPF since the NFF has both substantial NOx adsorption ability and can be formulated with high hydrocarbon or particulate oxidation activity. In some embodiments, the NFF could be placed before a conventional system since in addition to NOx adsorption capacity it has substantial SOx adsorption capacity. Which of these options would be favored depends on the operation of the diesel engine.

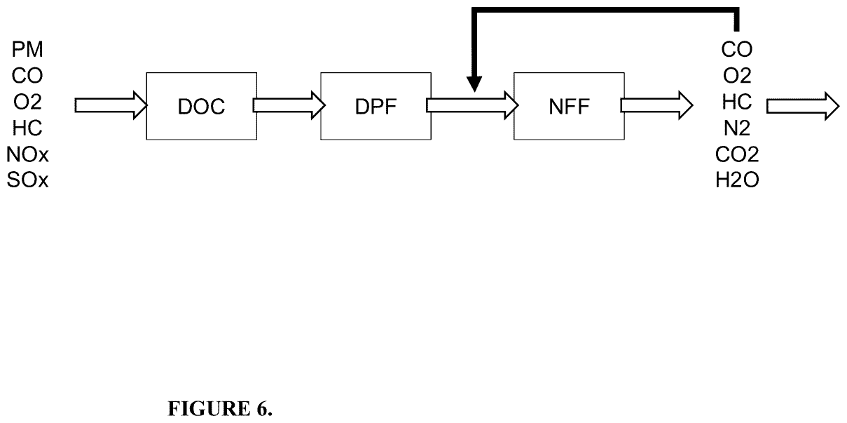

FIG. 6 presents a system for removing NOx from an exhaust gas in which the NFF replaces the SCR and the ASC, and a portion of the cleaned exhaust gas is recycled to the NFF in order to continuously regenerate it. This is a particularly advantageous arrangement for removing NOx from the exhaust of a diesel truck or car since it eliminates the need for a separate reservoir for ammonia, urea, or other reductant.

In some embodiments the same options for placement are available for a turbine combustion system or combustion flue gas cleanup. In those cases, one or more of the elements of the system could be omitted as unnecessary.

In some embodiments a reducing fluid is introduced into the combustion exhaust stream after a particulate filter or after a diesel oxidation catalyst, or after both, and before the NFF. In some embodiments a reducing fluid is introduced before the selective catalytic reduction catalyst (SCR). In other embodiments the reducing fluid is introduced after the selective catalytic reduction catalyst, but before the NFF. In each of these embodiments the reducing fluid can comprise NH3, urea, CO, H2, C1-C4 hydrocarbons, methanol, a stream recycled from the cleaned exhaust, or a mixture thereof. FIG. 6 is a schematic of a system for removing NOx from an exhaust fluid wherein the NOx fluid filter (NFF) is placed downstream of the diesel particulate filter (DPF) and a portion of the cleaned exhaust gas is recycled to the process after the DPF.

### Regeneration

Many filter media cannot be readily regenerated and must be discarded after use, increasing costs and presenting an environmental concern. The filtering media of the present invention are readily regenerated to restore their capacity for removing contaminants. In some embodiments, where the filtering media have been used to remove contaminants from gas streams, the material can be regenerated by controlled combustion in air or other oxygen-containing gas at a temperature of at least 80, 90, 100, 110, 120, 130, 140, 150, 160, or 170° C., or from 80 to 600, 80 to 250, 100 to 200, 120 to 180, or 130 to 170° C., or no more than 600, 500, 350, 320, 300, 280, 250, or 220° C. In some embodiments, the temperature can be controlled by diluting the air or oxygen-containing gas with inert gas such as N2, CO2, He, Ne, or an oxygen-depleted flue gas, or a mixture of these, to provide an oxygen-containing stream with less than 15, 10, 7, 5, or 2% by volume oxygen or from 0.1 to 15, 2 to 10, or 3 to 7% by volume oxygen.

In some embodiments, wherein the filter medium has been used to remove contaminants from exhaust streams the material can be regenerated by controlled combustion as above or by treatment with a dilute basic or acidic water stream wherein the pH of the water stream is no less than 5, 4.5, 4, 3.5, 3, or 2.5, or no more than 3, 3.5, 4, or 5, or from 2 to 6, 2.5 to 5, or 3 to 5 if it is an acidic stream, or no less than 8, 8.5, 9, 9.5, 10, or 10.5, or no more than 11, 10.5, 10, 9.5, 9, or 8.5, or from 8 to 11, 8.5 to 10, or 9 to 10 if it is a basic stream, or by a combination of controlled combustion followed by acid treatment, or basic treatment, or both, with either acid or basic treatment first. In some embodiments, the regenerated material typically recovers at least 50, 60, 70, 80, or 90% of its initial capacity or from 50 to 99, 60 to 95, 65 to 90, or 70 to 85% of its initial capacity. The filter media can be regenerated as many times as necessary. The filter media can be regenerated while remaining in a cartridge or the material can be removed from the cartridge, regenerated, and then at least part of it can be returned to service.

In some embodiments, where the filter media have been used to remove contaminants from gas streams, the materials can be regenerated by controlled reaction with a reducing fluid stream at a temperature of at least 30, 50, 80, 90, 100, 110, 120, 130, 140, 150, 160, or 170° C., or from 30 to 100, 80 to 250, 100 to 200, 120 to 180, or 130 to 170° C., or no more than 350, 320, 300, 280, 250, or 220° C. In some embodiments, the reducing fluid stream can comprise NH3, urea, methyl amine, hydrogen, CO, methane, methanol, ethanol, vapors from a diesel fuel storage tank, or a mixture of these, to provide a reducing stream with less than 15, 10, 7, 5, or 2% by volume reducing fluid or from 0.1 to 15, 2 to 10, or 3 to 7% by volume reducing fluid. In some embodiments, after regeneration with a reducing stream the filtering media are reactivated by exposure to air or other oxygen-containing gas at a temperature of at least 100, 150, 200, 250, 300, 350, 400, 450, 500, 550, 600, or 650° C., or from 100 to 750, 200 to 650, 300 to 600, or 400 to 550° C., or no more than 450, 550, 600, 650, 700, or 750° C. In some embodiments, the temperature can be controlled by diluting the reducing stream with inert gas such as N2, CO2, He, Ne, or a mixture of these, to provide a reducing stream with less than 15, 10, 7, 5, or 2% by volume of reducing fluid or from 0.1 to 15, 2 to 10, or 3 to 7% by volume of reducing fluid.

In some embodiments the material that has been used for contaminant removal can be recycled by dissolution in acidic water solution and contacted with sufficient solution of sodium, potassium, or ammonium hydroxide, bicarbonate, or carbonate, or a mixture of these, in water to form a homogeneous precipitate of hydroxides, carbonates, bicarbonates, hydroxycarbonates, or some mixture of these, which are optionally washed with water, then dried and calcined in air to convert the materials to oxides and drive off the unwanted materials, crushed and sieved to provide particles of filter media for further use.

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

### EXAMPLES

### Example 1

A sample of copper carbonate was calcined at 700 C overnight. The mass was crushed, mixed with an alumina sol, and calcined in a muffle furnace to a temperature of about 325° C. overnight. The resulting solid was ground and sieved to provide particles of 100 to 325 mesh (0.044 to 0.127 mm) adsorbent that was used for NOx adsorption and conversion experiments. The resulting material contained 96.5% CuO.

### Example 2

A sample of copper carbonate was calcined at 700 C overnight. The surface area of a sample of this material was measured as 1.8 m2/g by the BET N₂ adsorption method. The resulting solid was sieved and small particles of the solid were mixed with a silica sol and calcined in a muffle furnace to a temperature of about 325° C. overnight. The resulting solid was ground and sieved to provide particles of 100 to 325 mesh (0.044 to 0.127 mm) adsorbent that was used for NOx adsorption and conversion experiments. The resulting material contained 98.0% CuO.

### Example 3

A 17.55 gram sample (approx. 5.9 cc) of filter medium of Example 1 was charged to a cylindrical holder, prepared from McMaster #89785K846 SS 316 tubing with an ID of 0.37 inch and length of 6.0 inches held in place between McMaster #9446T32 2-micron porosity SS 316L discs at either end. A stream of gas containing 1000 ppm NO2 and 1000 ppm NO in nitrogen was passed through the material at room temperature (approx. 22° C.). The NO and NO2 concentrations in the outlet gas stream were measured by a Forensics Detectors brand Model: FD-600-NOx detector. Gas samples were taken periodically and the O2 content was determined on a PerkinElmer Clarus 590 GC model #NARL9590 by gas chromatography. The results of the 6-day experiment are collected in Table 1.

TABLE 1
Experimental results of a test of the material of Example 1 for the removal
of NO and NO2 from a gas stream at room temperature (about 22° C.)

| | | Minutes | Gas | | % | | % | |
|---|---|---|---|---|---|---|---|---|
| Exp't | | on | Inlet | ppm | NO2 | ppm | NO | |
| No. | Day | Stream | sccm | NO2 | Removal | NO | Removal | O2% |
| 1 | 1 | 0 | 16.0 | 0 | 100% | 0 | 100% | |
| 2 | 1 | 193 | 15.4 | 0 | 100% | 0 | 100% | |
| 3 | 2 | 1343 | 14.2 | 0 | 100% | 0 | 100% | |
| 4 | 2 | 1525 | 14.2 | 0 | 100% | 0 | 100% | |
| 5 | 4 | 4025 | 14.4 | 0 | 100% | 0 | 100% | |
| 6 | 4 | 4489 | 14.4 | 0 | 100% | 0 | 100% | 0.21% |
| 7 | 5 | 5494 | 14.2 | 0 | 100% | 0 | 100% | 0.21% |
| 8 | 5 | 5568 | 14.2 | 0 | 100% | 0 | 100% | |
| 9 | 5 | 5610 | 14.2 | 0 | 100% | 0 | 100% | |
| 10 | 5 | 5772 | 14.4 | 0 | 100% | 0 | 100% | 0.20% |
| 11 | 5 | 5841 | 14.4 | 0 | 100% | 0 | 100% | |
| 12 | 5 | 5885 | 14.4 | 0 | 100% | 0 | 100% | 0.31% |
| 13 | 6 | 6899 | 14.2 | 0 | 100% | 0 | 100% | 0.42% |
| 14 | 6 | 7012 | 14.2 | 0 | 100% | 0 | 100% | |
| 15 | 6 | 7068 | 14.4 | 0 | 100% | 0 | 100% | 0.22% |
| 16 | 6 | 7110 | 14.2 | 0 | 100% | 0 | 100% | 0.20% |
| 17 | 6 | 7140 | 14.4 | 0 | 100% | 0 | 100% | 0.31% |
| 18 | 6 | 7200 | 14.2 | 0 | 100% | 0 | 100% | |

The results in Table 1 show that the inventive material removed all the NO and NO2 from the process stream. The data in Table 1 show that the NOx concentration was below the detection limit of the detector, i.e. less than 1 ppm. The results in Table 1 also show that O2 was detected in the product stream, indicating that NO and/or NO2 were decomposed to liberate O2 by contact with the inventive material at room temperature.

### Example 4

The experiment in Example 3 was continued for 5 more days. The temperature remained as ambient (about 22° C.), and the feed gas was the same (1000 ppm each of NO and NO2 in N2) as in Example 3. The flow rate was changed as shown in Table 2, and the O2 concentration in the product gas was measured in addition to NO and NO2 concentrations. All of the experiments for which O2 was measured are collected in Table 2.

The data in Table 2 show that complete removal (100% removal) of NOx is achieved by the sorbent for a period of more than 9 days (12,700+ hours) at ambient temperature (about 22° C.). The data in Table 2 show that the NOx concentration was below the detection limit of the detector, i.e. less than 1 ppm. The data in Table 2 also show that oxygen evolved from the reaction of NOx with the sorbent for a period of more than 9 days at ambient temperature. The NOx adsorbed on the sorbent is more than 4.9% b/w of the mass of the sorbent after more than 9 days of treatment with NOx.

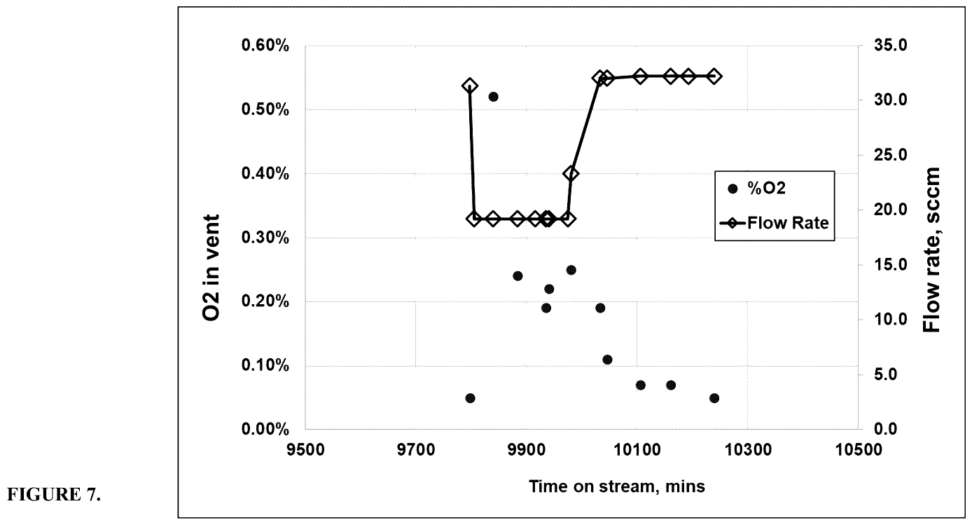

It was observed that the flow rate had a measurable impact on the O2 production of the process. At low flow rate (19.2 sccm) a higher concentration of O2 was observed in the product gas than was observed when the flow rate was higher (32.2 sccm). The data are presented in FIG. 7 that show the results for experiments on Day 8 of the test.

TABLE 2
Experimental results of a test of the material of Example 1 for the removal
of NO and NO2 from a gas stream at ambient temperature (about 22° C.).

| | | Mins | | % | | % | | |
|---|---|---|---|---|---|---|---|---|
| Exp't | | on | ppm | NO2 | ppm | NO | | |
| No | Day | stream | NO2 | Removal | NO | Removal | SCCM | O2% |
| 1 | 1 | 0 | 0 | 100% | 0 | 100% | 16.0 | 0 |
| 6 | 4 | 4489 | 0 | 100% | 0 | 100% | 14.4 | 0.21% |
| 7 | 5 | 5494 | 0 | 100% | 0 | 100% | 14.2 | 0.21% |
| 10 | 5 | 5772 | 0 | 100% | 0 | 100% | 14.4 | 0.20% |
| 12 | 5 | 5885 | 0 | 100% | 0 | 100% | 14.4 | 0.31% |
| 13 | 6 | 6899 | 0 | 100% | 0 | 100% | 14.2 | 0.42% |
| 15 | 6 | 7068 | 0 | 100% | 0 | 100% | 14.4 | 0.22% |
| 16 | 6 | 7110 | 0 | 100% | 0 | 100% | 14.2 | 0.20% |
| 17 | 6 | 7140 | 0 | 100% | 0 | 100% | 14.4 | 0.31% |
| 19 | 7 | 8485 | 0 | 100% | 0 | 100% | 51.4 | 0.27% |
| 20 | 7 | 8610 | 0 | 100% | 0 | 100% | 51.4 | 0.05% |
| 21 | 7 | 8659 | 0 | 100% | 0 | 100% | 30.7 | 0.05% |
| 22 | 7 | 8746 | 0 | 100% | 0 | 100% | 30.7 | 0.05% |
| 23 | 7 | 8773 | 0 | 100% | 0 | 100% | 30.4 | 0.05% |
| 24 | 8 | 9797 | 0 | 100% | 0 | 100% | 31.3 | 0.05% |
| 25 | 8 | 9839 | 0 | 100% | 0 | 100% | 19.2 | 0.52% |
| 26 | 8 | 9883 | 0 | 100% | 0 | 100% | 19.2 | 0.24% |
| 27 | 8 | 9935 | 0 | 100% | 0 | 100% | 19.2 | 0.19% |
| 28 | 8 | 9940 | 0 | 100% | 0 | 100% | 19.2 | 0.22% |
| 29 | 8 | 9980 | 0 | 100% | 0 | 100% | 23.3 | 0.25% |
| 30 | 8 | 10033 | 0 | 100% | 0 | 100% | 32.0 | 0.19% |
| 31 | 8 | 10045 | 0 | 100% | 0 | 100% | 32.0 | 0.11% |
| 32 | 8 | 10105 | 0 | 100% | 0 | 100% | 32.2 | 0.07% |
| 33 | 8 | 10160 | 0 | 100% | 0 | 100% | 32.2 | 0.07% |
| 34 | 8 | 10239 | 0 | 100% | 0 | 100% | 32.2 | 0.05% |
| 35 | 9 | 11597 | 0 | 100% | 0 | 100% | 32.0 | 0.04% |
| 36 | 9 | 11629 | 0 | 100% | 0 | 100% | 26.6 | 0.14% |
| 37 | 10 | 12671 | 0 | 100% | 0 | 100% | 25.7 | 0.08% |
| 38 | 10 | 12711 | 0 | 100% | 0 | 100% | 34.4 | 0.05% |

FIG. 7 is a chart showing the effect of flow rate on NO/NOx reduction to N2+O2 when using the inventive filter medium of claim 1.

### Example 5

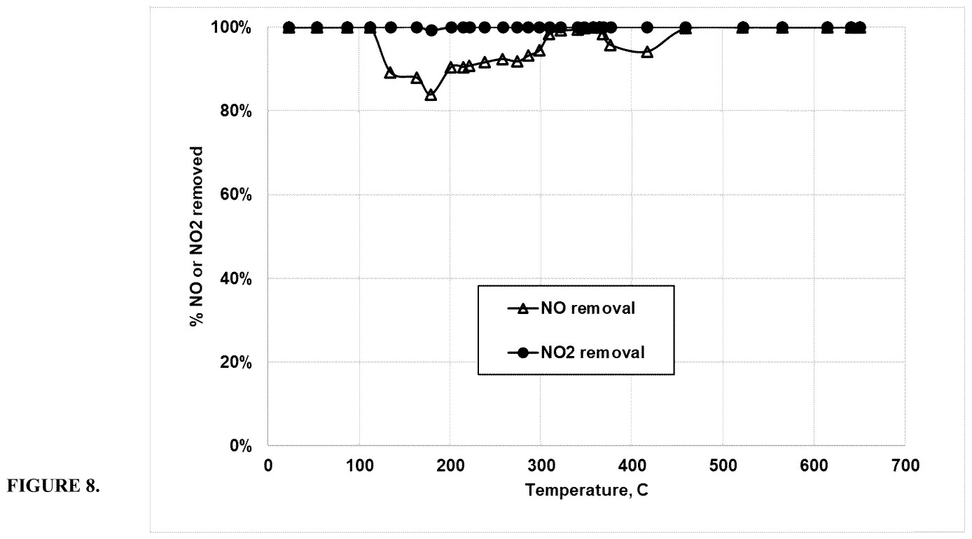

A 16.36-gram sample of the sorbent material prepared in Example 1 was charged to a cylindrical holder as described above. A stream of gas containing 1000 ppm NO2 and 1000 ppm NO in nitrogen was passed through the material with a flow rate of 26 sccm as the temperature was raised from room temperature to 650° C. over the course of 7 hours. The NO and NO2 concentrations in the outlet gas stream were measured by a Forensics Detectors brand Model: FD-600-NOx detector. The results are presented in Table 3 and FIG. 8.

TABLE 3
Experiments on the removal of NO and NO2 from a
N2 stream containing 1000 ppm NO and 1000 ppm
NO2 at temperatures from 22 to 650° C. with
filter medium prepared according to Example 1.

| | Time on | | | % | | % | % |
|---|---|---|---|---|---|---|---|
| Exp't | stream | Temp | ppm | NO2 | ppm | NO | NOx |
| No. | Mins | C. | NO2 | Removal | NO | Removal | Removal |
| 39 | 0 | 22.6 | 0 | 100% | 0 | 100% | 100% |
| 40 | 16 | 53.5 | 0 | 100% | 0 | 100% | 100% |
| 41 | 26 | 86.6 | 0 | 100% | 0 | 100% | 100% |
| 42 | 36 | 112.0 | 0 | 100% | 0 | 100% | 100% |
| 43 | 44 | 134.2 | 0 | 100% | 108 | 89% | 95% |
| 44 | 60 | 163.2 | 0 | 100% | 121 | 88% | 94% |
| 45 | 73 | 178.7 | 7 | 99% | 161 | 84% | 92% |
| 46 | 92 | 200.8 | 0 | 100% | 95 | 91% | 95% |
| 47 | 118 | 214.2 | 0 | 100% | 95 | 91% | 95% |
| 48 | 131 | 221.1 | 0 | 100% | 92 | 91% | 95% |
| 49 | 153 | 237.6 | 0 | 100% | 84 | 92% | 96% |
| 50 | 166 | 257.5 | 0 | 100% | 76 | 92% | 96% |
| 51 | 176 | 273.6 | 0 | 100% | 82 | 92% | 96% |
| 52 | 182 | 285.5 | 0 | 100% | 68 | 93% | 97% |
| 53 | 192 | 297.7 | 0 | 100% | 55 | 95% | 97% |
| 54 | 209 | 308.7 | 0 | 100% | 16 | 98% | 99% |
| 55 | 226 | 321.5 | 0 | 100% | 8 | 99% | 99.6% |
| 56 | 243 | 339.8 | 0 | 100% | 5 | 100% | 99.7% |
| 57 | 256 | 347.1 | 0 | 100% | 3 | 100% | 99.9% |
| 58 | 266 | 357.1 | 0 | 100% | 0 | 100% | 100% |
| 59 | 290 | 364.1 | 0 | 100% | 0 | 100% | 100% |
| 60 | 317 | 368.1 | 0 | 100% | 16 | 98% | 99% |
| 61 | 337 | 376.0 | 0 | 100% | 42 | 96% | 98% |
| 62 | 352 | 416.3 | 0 | 100% | 58 | 94% | 97% |
| 63 | 367 | 458.3 | 0 | 100% | 3 | 100% | 99.9% |
| 64 | 383 | 521.3 | 0 | 100% | 0 | 100% | 100% |
| 65 | 397 | 564.9 | 0 | 100% | 0 | 100% | 100% |
| 66 | 416 | 614.2 | 0 | 100% | 0 | 100% | 100% |
| 67 | 424 | 640.2 | 0 | 100% | 0 | 100% | 100% |
| 68 | 432 | 650.1 | 0 | 100% | 0 | 100% | 100% |

The results in Table 3 show that NO and NO2 are removed very effectively at temperatures from ambient temperature (about 22° C.) to 650° C. The results show that greater than 99% NO2 is removed, and that at least 84% of NO is removed at temperatures between 22 and 650° C. using the invention, and NO is completely removed at temperatures below 134° C., between 29° and 373° C., and at 367° C. and above. The results show that at least 92% of the NOx in a 1:1 mixture of NO and NOx is removed at all temperatures from 22 to 650° C.

The results in Table 3 and FIG. 8 show that a filter medium containing alumina binding agent is effective for the removal of NOx at temperatures from 22 to 560° C.

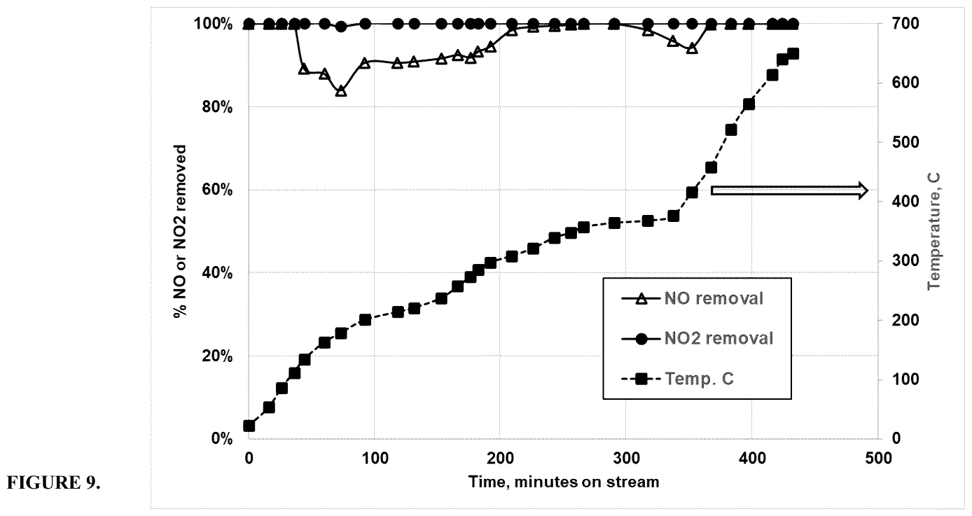

FIG. 9 is a chart showing removal of NO and NO2 from a N2 stream as a function of time and temperature with inventive filter media of Example 1.

### Example 6

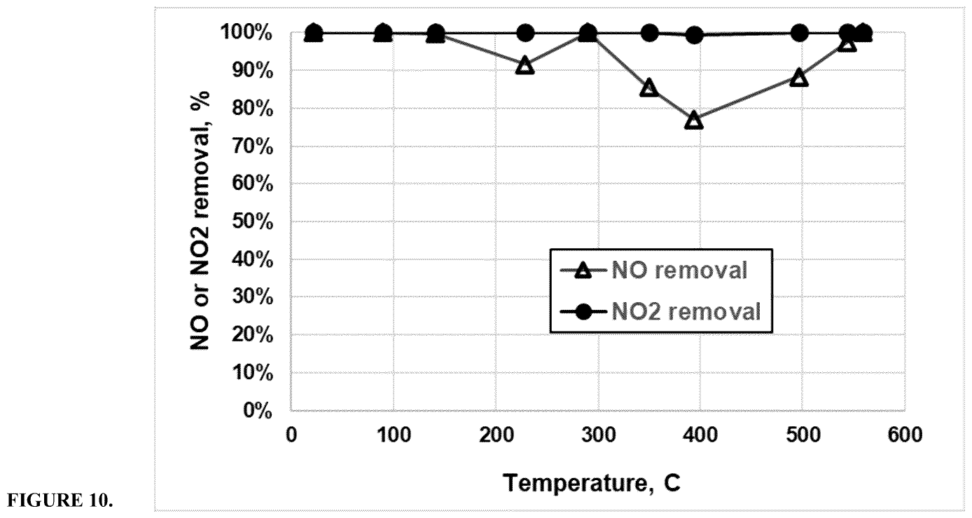

A 17.58-gram sample of a sorbent material prepared as in Example 2 was charged to a cylindrical holder as before. A stream of gas containing 1000 ppm NO2 and 1000 ppm NO in nitrogen was passed through the material with a flow rate of 31 sccm as the temperature was raised from room temperature to 560° C. over the course of 4 hours. The NO and NO2 concentrations in the outlet gas stream were measured by a Forensics Detectors brand Model: FD-600-NOx detector. The results are presented in Table 4 and FIG. 10. The system was permitted to cool to ambient temperature (about 22° C.) overnight and then the experiment was repeated with the same flow rate of NOx containing gas at ambient temperature.

TABLE 4
Experiments on the removal of NO and NO2 from a
N2 stream containing 1000 ppm NO and 1000 ppm
NO2 at temperatures from 22 to 560° C. with
filter medium prepared according to Example 2.

| | | | | % | | % | % |
|---|---|---|---|---|---|---|---|
| | | Degrees | ppm | NO2 | ppm | NO | NOx |
| Expt | Mins | C. | NO2 | Removal | NO | Removal | removal |
| 69 | 0 | 21.7 | 0 | 100% | 0 | 100% | 100% |
| 70 | 45 | 89.6 | 0 | 100% | 0 | 100% | 100% |
| 71 | 62 | 141.0 | 0 | 100% | 3 | 100% | 100% |
| 72 | 104 | 228.7 | 0 | 100% | 84 | 92% | 96% |
| 73 | 136 | 290.0 | 0 | 100% | 0 | 100% | 100% |
| 74 | 166 | 349.6 | 0 | 100% | 145 | 86% | 93% |
| 75 | 186 | 393.4 | 6 | 99% | 229 | 77% | 88% |
| 76 | 227 | 495.8 | 0 | 100% | 116 | 88% | 94% |
| 77 | 242 | 543.5 | 0 | 100% | 24 | 98% | 99% |
| 78 | 247 | 558.1 | 0 | 100% | 0 | 100% | 100% |
| 79 | 1438 | 22.0 | 0 | 100% | 0 | 100% | 100% |
| 80 | 1820 | 22.0 | 0 | 100% | 113 | 89% | 94% |

FIG. 10 is a chart showing experimental data for the removal of NO and NO2 from N2 as a function of temperature with the filter medium of Example 2.

The results in Table 4 and FIG. 10 show that NO and NO2 are removed very effectively at temperatures from ambient temperature (about 22° C.) to 560° C. with the filter medium of Example 2. The results show that greater than 99% NO2 is removed at all temperatures, and that at least 77% of NO is removed at temperatures between 22 and 560° C. using the invention, and NO is completely removed at temperatures up to 141° C. The results in Table 4 show that at least 88% of the NOx in a 1:1 mixture of NO and NOx is removed at all temperatures from 22 to 560° C. with the material of Example 2.

The results in Table 4 show that a filter medium containing silica binding agent is effective for the removal of NOx at temperatures from 22 to 560° C. The results in Table 4 show that after exposure to a NOx-containing stream at temperatures up to 560° C. the material retained its ability to remove NOx at ambient temperature (Experiments 79 and 80). The surprising results in Table 4 show that the active material of this invention with a surface area of only 1.8 m2/g was effective for removal of NOx from a gas stream.

### Example 7

A 17.55-gram sample (approx. 5.9 cc) of filter medium of Example 2 was charged to a cylindrical holder as described previously. A stream of gas containing 1000 ppm NO2 and 1000 ppm NO in nitrogen was passed through the material at room temperature (approx. 22° C.). The NO and NO2 concentrations in the outlet gas stream were measured by a Forensics Detectors brand Model: FD-600-NOx detector. The results of the 4-day experiment are collected in Table 5.

TABLE 5
Experimental results of a test of the material
of Example 2 for the removal of NO and NO2 from
a gas stream at room temperature (about 22° C.).

| | | | | % | | % | |
|---|---|---|---|---|---|---|---|
| | | | ppm | NO2 | ppm | NO | |
| Exp't | Day | Mins | NO2 | Removal | NO | Removal | SCCM |
| 81 | 1 | 0 | 0 | 100% | 0 | 100% | 19.8 |
| 82 | 1 | 224 | 0 | 100% | 0 | 100% | 20.4 |
| 83 | 2 | 1294 | 0 | 100% | 0 | 100% | 20.2 |
| 84 | 3 | 2741 | 0 | 100% | 0 | 100% | 20.4 |
| 85 | 3 | 3094 | 0 | 100% | 0 | 100% | 20.4 |
| 86 | 4 | 4281 | 0 | 100% | 0 | 100% | 20.6 |
| 87 | 4 | 4370 | 0 | 100% | 0 | 100% | 20.8 |
| 88 | 4 | 4397 | 0 | 100% | 0 | 100% | 20.8 |

The results in Table 5 show that the material with a silica binder was very effective at removing both NO and NO2 at room temperature. The results in Table 5 show that the material with a silica binder removed essentially all of both NO and NO2 at room temperature. The data in Table 5 show that the NOx concentration was below the detection limit of the detector, or less than 1 ppm. The surprising results in Table 5 show that the active material of this invention with a surface area of only 1.8 m²/g was effective for removal of NOx from a gas stream.

### Example 8

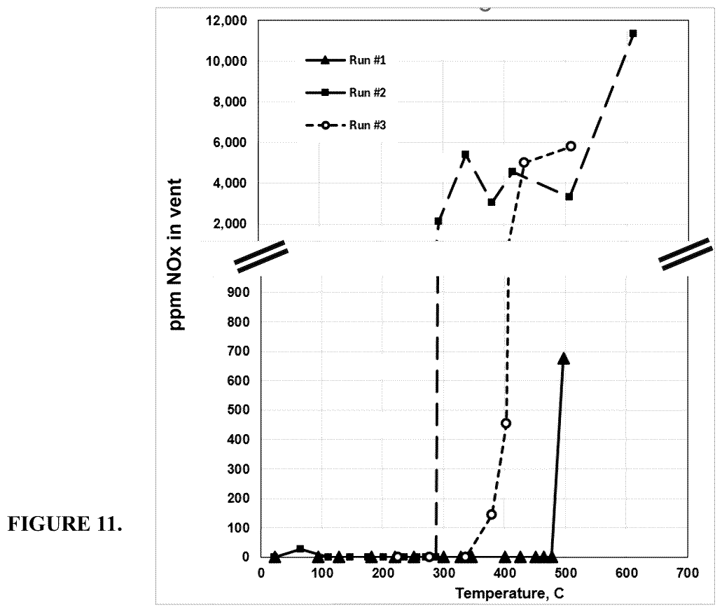

An 18.06-gram sample of filter medium of Example 1 was charged to a cylindrical holder as described previously. A 21 sccm stream of gas containing 1000 ppm NO2 and 1000 ppm NO in nitrogen was passed through the material at room temperature (approx. 22° C.). After 4150 minutes on stream a 3.5 sccm flow of 25% O2 in N2 was introduced (net 3.9% O2 in the combined gas streams) and the sample was heated to 495° C., releasing NOx, and then allowed to cool to ambient temperature. A stream of gas feed containing O2 was introduced (19 sccm 1000 ppm NO2, 1000 ppm NO; 3.5 sccm 25% O2 in N2) and the sample was slowly heated to 497° C. The NO and NO2 concentrations in the outlet gas stream were measured by a Forensics Detectors brand Model: FD-600-NOx detector, and are shown in FIG. 11 as Run #1. At 497° C. NOx was still being adsorbed by the filter medium since the concentration in the vent was 600 ppm, lower than in the feed gas; NOx remained adsorbed on the filter medium at 497° C.

After allowing the sample to cool to room temperature, the experiment was repeated with 19 sccm of the NOx-containing gas and 3.8 sccm of the 25% O2 in N2 gas mixture flowing. The sample was slowly heated to 600° C. and the NOx concentration in the vent was measured by GC and is presented in FIG. 11 as Run #2. Note that NOx was detected in the vent gas at a much lower temperature (approx. 300° C.) than in Run #1. In order to remove NOx that was adsorbed on the filter medium the temperature was raised to 600° C., and very high concentrations of NOx were observed in the gas vent indicating desorption was occurring.

The sample from Run #2 in which NOx had at least partially desorbed was again allowed to cool to room temperature and the experiment was repeated with a 20 sccm flow of the NOx mixture and 3.8 sccm flow of the 25% O2 mixture. The sample was heated to 501° C. and the NOx concentration in the vent was measured by GC and presented in FIG. 11 as Run #3.

The results for Run #1 in FIG. 11 show that the filter medium removes essentially 100% of NOx from a gas mixture containing O2 as well as NO and NO2 at temperatures as high as 495° C.

The results in Run #2 of FIG. 11 show that when the filter medium contains adsorbed NOx the adsorption of additional NOx continues to about 300° C., but at higher temperatures (300-500° C.) adsorption competes with desorption since the vent gas contains somewhat higher concentrations of NOx than the feed. At the highest temperature, 600 C, gross desorption of NOx occurs, significantly reducing the amount of NOx adsorbed on the filter medium.

The results of Run #3 of FIG. 11 that use the filter medium from which NOx had been at least partially desorbed, show that the filter medium regained its ability to adsorb NOx, as indicated by the higher temperature (380° C.) at which NOx appeared in the vent gas. This result shows that even in an O2-containing mixture the adsorption is reversible and the filter medium can be regenerated by heating to a high temperature.

FIG. 11 is a chart showing experimental data for the removal of NO and NO2 from a stream containing O2.

### Example 9

Copper carbonate, copper nitrate, gamma alumina, and an alumina sol were thoroughly mixed to form a very thick mud and chopped into small pieces. The material was transferred to ceramic trays and calcined in a muffle furnace to a temperature of 700° C. overnight. The resulting solid was ground and sieved to provide particles of adsorbent that were used for NOx adsorption and conversion experiments. The resulting solid contained 80% copper oxide 20% alumina by weight.

### Example 10

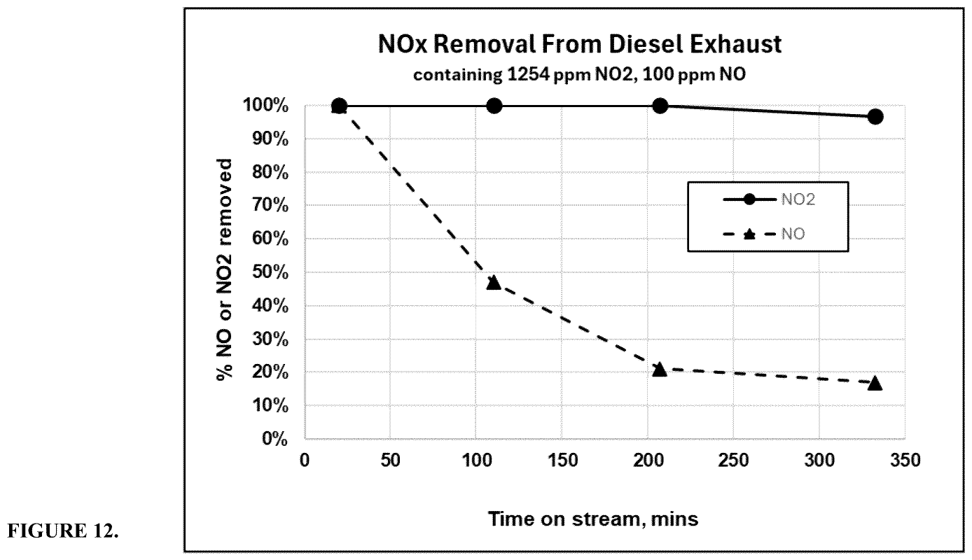

A 13.35 kg sample of 4-14 mesh (1.41-4.76 mm) filter medium of Example 9 was charged to a 6-inch (15 cm) diameter cylindrical holder adapted to accept the exhaust from a diesel-powered tractor. The system did not contain a particulate trap. The unfiltered exhaust was measured to contain 1254 ppm of NO2 and 100 ppm of NO, total 1354 ppm NOx by volume. The exhaust was directed through the filter medium and the NOx concentrations were monitored. The temperature of the filter was about 83° C. The results appear in FIG. 12. The experiment was continued overnight but was automatically terminated when the pressure drop across the filter increased, likely due to soot buildup on the filter medium.

FIG. 12 is a chart showing experimental data for the removal of NO and NO2 from diesel exhaust containing particulates and other impurities.

The results in FIG. 12 show that the filter medium removes nearly all of the NO2 from the diesel exhaust and some of the NO. The decline in NO removal was accompanied by a slow, steady increase in the pressure drop across the filter indicative of soot buildup; soot was observed on a sample removed from the holder. Other components in the exhaust gas (e.g. SO2, partial oxidation products) also may have been trapped by the filter medium and contributed to the decline in NO removal.

### Example 11—Regeneration

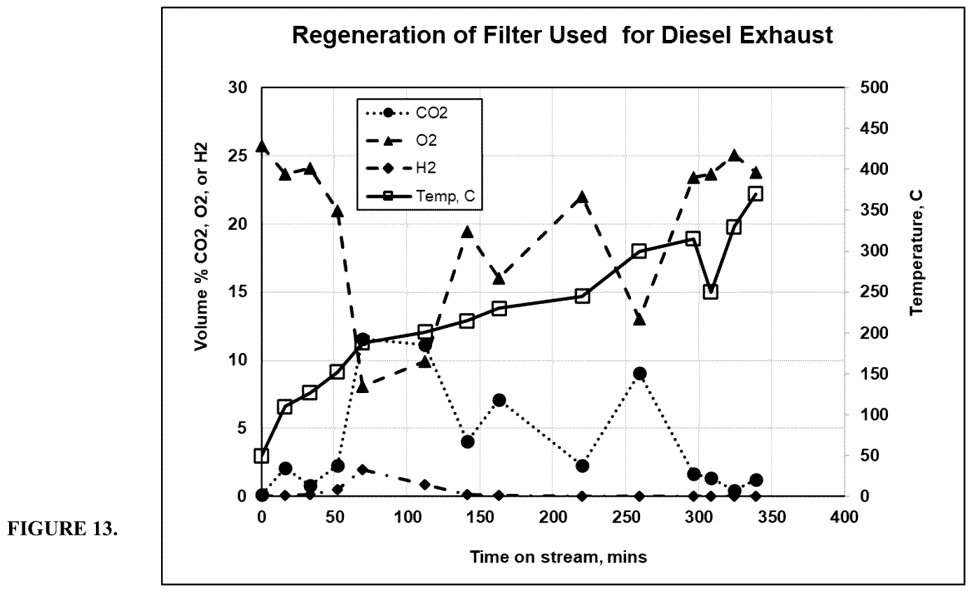

A 41.93-gram sample of the filter medium used in Example 10 that had been clogged with soot was dried in flowing air in a convection oven for 4 hours at 200° C., resulting in 41.81 grams of dried material. A 21.33-gram sample of the dried material was then charged to a cylindrical test device and regenerated by slowly heating in 8 sccm flowing 25% O2 in N₂. The vent gases were monitored by GC, and the results are presented in FIG. 13. When the temperature reached 150° C. the concentration of O2 decreased and the concentration of CO2 greatly increased, indicating that the carbonaceous soot was burning away. Heating was continued until a temperature of 370° C. was reached, the CO2 content dropped below 1.5%, and the O2 concentration returned to near the feed concentration of 25% by volume. This was taken as indicating that most of the soot had been burnt away.

FIG. 13 is a chart showing experimental data on the regeneration of filter medium that had been used for NOx removal from diesel exhaust from which soot and other impurities had not been removed.

### Example 12

The 21.33-gram sample that had been regenerated in Example 11 and dried was cooled to room temperature in N₂ and a stream of 12 sccm of 1000 ppm NO and 1000 ppm NO2 in N₂ was passed through the filter medium. The temperature was raised slowly from 22 to 589° C.

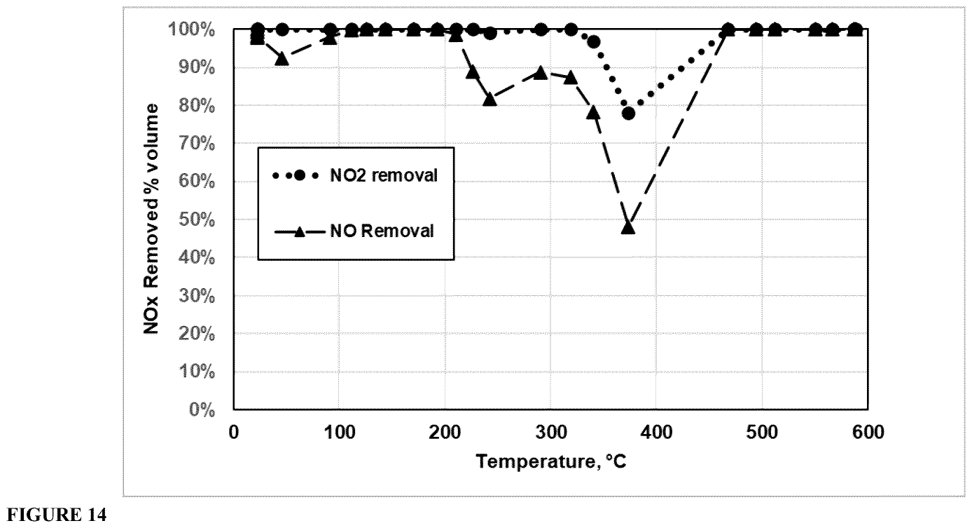

The results in FIG. 14 show that NO2 removal was 100% from 22 to 340° C., and above 370° C. The removal of NO was greater than 80% from 22 to 340° C., and then 100% at temperatures above 370° C. At temperatures above 370° C. traces of H2 and CO2 were observed, indicating that some soot remained in the sample. The results indicate that the filter medium can be regenerated after having been used to remove NOx from a diesel exhaust stream, and can regain its ability to trap NOx, even when the diesel exhaust has not had particulates or other impurities (e.g. SO2) removed.

FIG. 14 is a chart showing experimental data for the removal of NO and NO2 from a N2 stream by filter medium that had been regenerated in Example 11 after use for a cleanup of diesel exhaust.

### Example 13

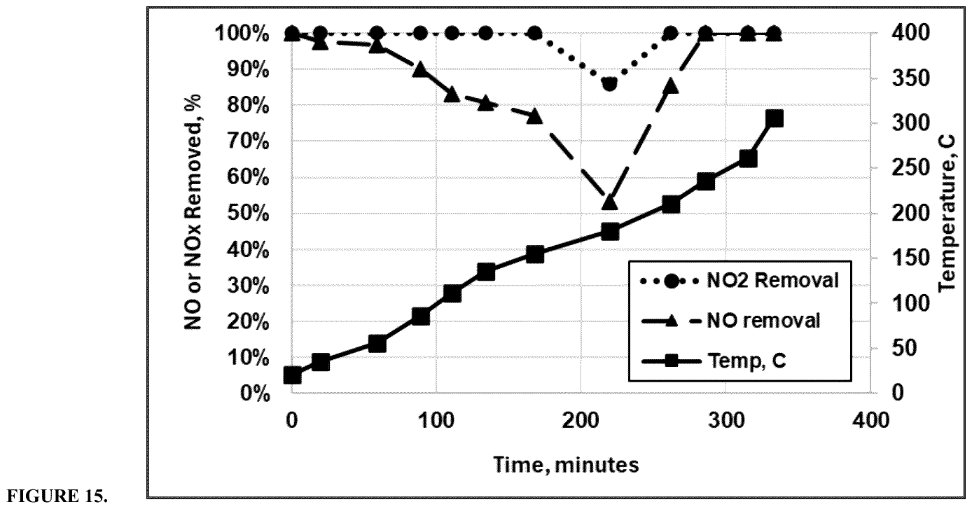

A 28.33-gram sample of the filter medium that had been used to treat the diesel exhaust in Example 10 and contained soot, was tested for NOx removal without regeneration. The material was charged to a cylindrical holder held at room temperature and a stream of 14 sccm of 1000 ppm NO and 1000 ppm NO2 in N₂ was passed through the filter medium as it was heated to 329 C over the course of 350 minutes. The data are presented in FIG. 15.

FIG. 15 is a chart showing that the soot-containing NOx fluid filter removed more than 85% of the NO2 at all temperatures up to 329 C, and that from 20 through 168° C., and above 210° C. 100% of the NO2 was removed. At least 54% of the NO was removed at all temperatures from 20 to 329° C. These NOx removals were attained even with soot-coated NOx filter medium.

### Example 14

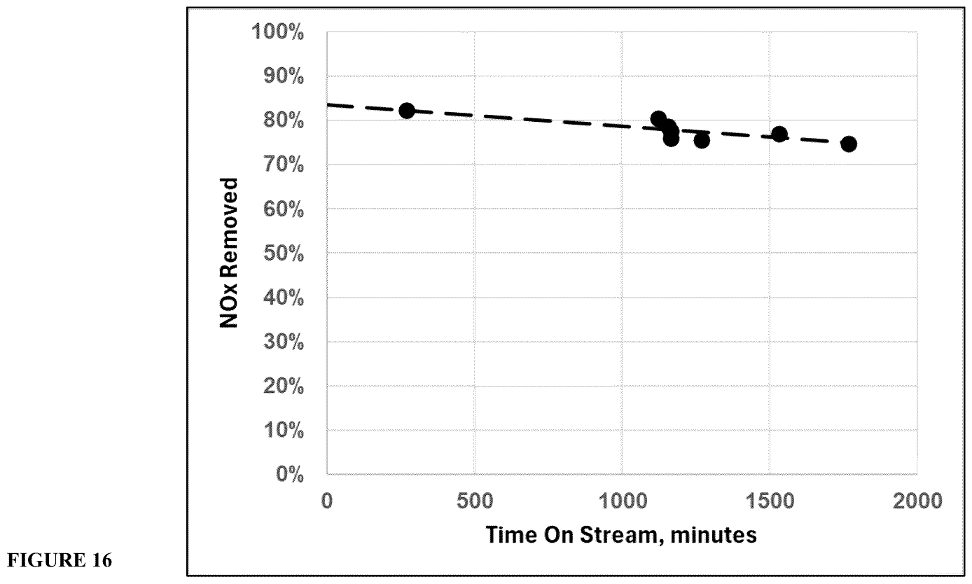

A 13.35-kg sample of the filter medium of Example 9 was charged to a 6-inch (15 cm) diameter cylindrical holder adapted to accept the exhaust from a diesel-powered tractor. The system contained a Mercedes particulate filter followed by the filter medium. The stream exiting the particle filter was measured to contain 1342 ppm of NO2 and 79 ppm of NO, total 1421 ppm NOX by volume. The exit steam from the particle filter was directed through the filter medium and the NOx concentrations were monitored. The temperature of the filter was about 83° C. The results appear in FIG. 16.

FIG. 16 is a chart showing the NOx removal rate vs time on stream for the combination of a particulate filter and one of the filter media of this invention. It shows that the combination of a particle filter and the filter medium of Example 9 remove more than 70% of the NOx from a raw diesel exhaust stream.

While the invention has been described in detail and with reference to specific embodiments thereof, it will be apparent to one skilled in the art that various changes and modifications can be made therein without departing from the spirit and scope thereof. Thus, it is intended that the invention covers the modifications and variations of this invention provided they come within the scope of the appended claims and their equivalents.

### LIST OF REFERENCE NUMBERS

1 Filter system
2 fluid
3 Fluid line
10 filter housing
11 filter blocks
12 plugs
13 channels
14 hollow pineapple structure
15 interior chamber
20 static mixing device
21 internal fixed structures
30 fluid line
31 exhaust line
32 collection vessel

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A fluid filter device comprising a housing with adapters at either end to permit the housing to be fitted into a fluid flow system or exhaust system, such housing containing filter media comprising particles and/or one or more porous shaped bodies comprising oxides of copper and one or more oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, or zirconium.

2. The fluid filter device of claim 1, wherein the housing is cylindrical and contains a replaceable filtering cartridge containing the filter media.

3. The fluid filter device of claim 1, further comprising wherein the filter media comprises catalytically active amounts of one or more of palladium, platinum, gold, and rhodium, wherein the atom ratio of the sum of such elements to that of copper is at least 0.001.

4. The fluid filter device of claim 1, further comprising wherein the filter media comprises a binder consisting of one of the group of alumina, boehmite, silica, graphite, titania, zirconia, ceria, lanthanum oxides, thoria, aluminosilicates, clays, hydrotalcites, or sols of these, or some combination thereof; such filtering media having a porosity in the range of 0.4 to 0.95 and wherein the particles and/or porous shaped bodies comprise micropores, mesopores, and macropores.

5. The fluid filter device of claim 1, wherein the filter media comprises a shaped porous filter block bound together with one or more agglomerating agents and in the shape of a filter cartridge.

6. The fluid filter device of claim 5, wherein the filter media comprises a honeycomb of one or more of alumina, silica, clay, cordierite (2MgO·2Al₂O₃·5SiO₂), silicon carbide, mullite, zirconia, or ceria, that has been coated with a mixture of oxides of copper and one or more of the oxides of aluminum, barium, boron, calcium, cerium, cesium, dysprosium, erbium, europium, gadolinium, gallium, hafnium, holmium, indium, iron, lanthanum, lithium, lutetium, magnesium, manganese, molybdenum, neodymium, praseodymium, samarium, silicon, silver, strontium, titanium, vanadium, ytterbium, yttrium, zinc, and zirconium.

7. The fluid filter of claim 1 wherein the filtering media have been regenerated by reduction with a reducing gas, or treatment with dilute base, dilute acid, or both acid and base.

8. The fluid filter of claim 1 wherein the surface area of the filter media is less than 20 m2/g.

9. A process for removing nitrogen oxides from a fluid stream comprising
1. placing the fluid filter device of claim 1 in a fluid stream,
2. passing the fluid stream through the fluid filter device,
3. recovering purified fluid as it exits the fluid filter device, and
4. either processing the recovered fluid further or venting the recovered fluid to the atmosphere.

10. The process of claim 9, wherein the filter media of the fluid filter device comprises catalytically active amounts of one or more of Pd, Pt, and Rh, wherein the atom ratio of the sum of such elements to that of copper is at least 0.001.

11. The process of claim 9, wherein the filter media of the fluid filter device comprises at least 50% by weight oxides of copper.

12. The process of claim 9, comprising the fluid filter device of claim 19.

13. The process of claim 9, wherein the fluid stream containing oxides of nitrogen comprises an exhaust stream from a gasoline or diesel engine, a turbine generator, or a flue gas from a combustion process.

14. The process of claim 9, wherein the fluid stream is an exhaust stream that has passed through one or more of particulate filters, hydrocarbon oxidation catalysts, NO oxidation catalysts, selective catalytic reduction catalysts, soot oxidation catalysts, or SOx filters before contacting the fluid filter.

15. The process of claim 9, wherein the fluid stream comprises at least 10 ppm NOx by volume.

16. The process of claim 9, wherein the fluid stream is at a temperature from 20 to 500° C.

17. The process of claim 9, wherein the fluid filter has been regenerated to restore NOx removal activity.

18. The process of claim 9, wherein the fluid filter has been regenerated and reactivated to restore NOx removal activity.

19. The process of claim 9, wherein the purified gas stream comprises less than 4 ppb NOx by volume.

20. A system for removing NOx from a fluid stream, comprising:
a. a fluid stream of NOx-containing gas,
b. the fluid filter device of claim 1, and
c. an exhaust line, a line to a conversion processing facility, or a collection vessel,
such system comprising the following steps,
1. placing the fluid filter device in the fluid stream,
2. passing the fluid stream through the fluid filter device,
3. recovering purified fluid as it exits the fluid filter device, and,
4. either processing the recovered fluid further or venting the recovered fluid to the atmosphere.

21. The system of claim 20, further comprising one or more additional filtering or conversion media chosen from among particulate filters, hydrocarbon oxidation catalysts, NO oxidation catalysts, selective catalytic reduction catalysts, soot oxidation catalysts, ammonia slip catalysts, and SOx filter media.

22. The system of claim 20, further comprising:
two or more fluid filter devices of claim 1,
wherein the fluid stream runs through the two or more fluid filter devices in succession prior to entering the exhaust line.

23. The system of claim 20, wherein the filter media are regenerated by treatment with a reducing fluid selected from among H2, C1-C4 hydrocarbons, CO, ammonia, urea, methyl amine, methanol, ethanol, vapors from a diesel fuel storage tank, a recycled purified stream, or some combination of these.

24. The system of claim 20 wherein the filter media is reactivated by treatment with an oxygen-containing gas.
